(19) United States
(12) Patent Application Publication
(10) Pub. No.: US 2026/0261510 A1
(43) Pub. Date: Sep. 3, 2026

(54) Mesh Network Creation for Variable Energy-Harvesting Devices

(71) Applicant: PassiveLogic, Inc., Holladay, UT (US)

(72) Inventor: Marciano Carter Preciado, Holladay, UT (US)

(21) Appl. No.: 19/553,293

(22) Filed: Feb. 28, 2026

Related U.S. Application Data
(60) Provisional application No. 63/765,431, filed on Feb. 28, 2025.

(51) Int. Cl. H04L 45/48; H04W 52/02

(52) U.S. Cl. CPC H04L 45/48; H04W 52/0219

(57) ABSTRACT

Various embodiments for forming and managing a wireless network of variable power devices are disclosed. Each device may obtain energy from a variable energy source, such as ambient light, and may store historical power income data and power consumption data. A processor determines, over a selected historical time period, an average power income and an excess energy value for each device. Based on the excess energy value and modeled communication throughput costs, a maximum number of descendant devices supportable by each device is determined. A network tree is constructed such that no device is assigned more descendant devices than its determined capacity. In some embodiments, signal strength between devices is estimated using environmental modeling that accounts for structural obstacles and antenna radiation characteristics. The network topology may be reorganized periodically based on updated historical power data to maintain sustainable operation and improve network reliability.

### TECHNICAL FIELD

Various embodiments described herein relate to creating low-power networks and more specifically, but not exclusively, to low power networks with devices that have variable power availability.

### BACKGROUND

Today, low power networks are used for many applications, such as internet of things applications, smart home automation, wearable devices, and other applications where devices should be able to operate for extended periods of time without an easy way to plug the devices in to power them, to replace their batteries, and so forth. However, current applications have not fully realized the untapped value in this approach

Applications for solar-powered sensors include environmental monitoring, agriculture, weather stations, wildlife tracking, and more. These sensors are particularly useful in locations where it's impractical or costly to run power cables or change batteries frequently. However, it's important to design these systems carefully to ensure reliable operation under varying light conditions and to manage the energy balance effectively to avoid sensor downtime due to low battery levels which can, among other problems, cause network-link breakages in mesh networks.

### SUMMARY

This summary is provided to introduce a selection of concepts in a simplified form that are further described below in the Detailed Description section. This summary does not identify required or essential features of the claimed subject matter. The innovation is defined with claims, and to the extent this Summary conflicts with the claims, the claims should prevail.

Various embodiments described herein relate to systems and methods for constructing and maintaining a communication network comprising devices with variable power availability, such as energy-harvesting devices. In particular, embodiments provide techniques for creating a network topology that accounts for device-specific power income, power consumption, and communication throughput requirements to improve network longevity and reliability.

In some embodiments, a processor calculates a power income for each device in a plurality of devices, where at least some of the devices obtain energy from variable sources such as solar energy. Based on stored or modeled information including power income history, device power consumption, and device throughput power requirements, an allowed number of descendant devices is determined for each device. This allowed number represents the maximum number of dependent or downstream devices that a given device can support in a network tree without exceeding its available energy capacity.

Using these allowed descendant values, a network tree is constructed in which the number of descendant devices associated with each device does not exceed its determined limit. The network tree may be generated to additionally optimize communication efficiency, such as by minimizing path length to a root or gateway node and by selecting connections based on signal strength.

In certain embodiments, signal strength between devices is estimated using an attenuation model that accounts for physical characteristics of the environment. A digital twin or similar environmental model may be used to determine distances between devices and attenuation through obstacles such as walls, floors, ceilings, and windows. Material composition, thickness, resistance values, angle of incidence, and antenna radiation characteristics may be incorporated to estimate communication feasibility between device pairs. These signal strength determinations may be used to constrain or weight allowable connections in the network topology.

A power-aware routing heuristic may then be applied to assign parent-child relationships among devices, reassign connections where necessary, and reorganize the network to satisfy power constraints while maintaining efficient routing paths. In some embodiments, routing messages are transmitted through the resulting network tree, and the topology may be periodically updated to reflect changes in device power availability or environmental conditions.

The disclosed techniques enable formation of resilient mesh or tree-based networks that accommodate heterogeneous, energy-harvesting devices, reduce the likelihood of network link failures due to power depletion, and improve overall network stability in environments with variable lighting or other fluctuating energy conditions.

### BRIEF DESCRIPTION OF THE FIGURES

In order to better understand various example embodiments, reference is made to the accompanying drawings, wherein:

FIG. 1 illustrates an example system for implementation of various embodiments;

FIG. 2 illustrates an example system for implementing a controller device;

FIG. 3 illustrates an example digital twin for use in various embodiments;

FIG. 4 illustrates an example of a device;

FIG. 5 illustrates an example method for creating a network with variable power devices;

FIG. 6 illustrates an example method for determining a power number;

FIG. 7A illustrates a series of variable power devices and their associated power numbers;

FIG. 7B illustrates a series of variable power devices with potential wireless networking links with their peers;

FIG. 7C illustrates an example of creating a network with variable power devices with chosen wireless networking links that take into account the power number for longevity;

FIGS. 8A and 8B and illustrate an example method for determining signal strength between a transmitter and a receiver device;

FIG. 9A illustrates an example possible network attenuation within a structure between devices;

FIG. 9B illustrates an example of network attenuation between two locations in a structure;

FIG. 10 illustrates example structure composition that may be encoded within a database;

FIG. 11 illustrates an example screenshot of a way to input structure material information within a database.

FIG. 12 illustrates a relationship between a neural network used to model a network and the network itself

FIGS. 13A, 13B, and 13C illustrate example methods for using a heuristic to create a network with variable power devices;

FIG. 14 illustrates an exemplary polar gain chart.

FIG. 15 illustrates an example hardware diagram for implementing network creation.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as use herein, refers to a non-exclusive “or” (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

Low-power wireless networks are widely deployed in applications such as building automation, environmental sensing, industrial monitoring, smart homes, and Internet of Things (IoT) systems. Many such networks include battery-operated or energy-harvesting devices intended to operate for extended periods without direct wired power. Although these networks offer flexibility and reduced installation costs, existing approaches suffer from several technical limitations.

A primary limitation of current low-power mesh and tree-based networking technologies is the assumption of static or uniformly available power across network nodes. Conventional routing algorithms typically optimize for shortest path, lowest latency, or signal strength without accounting for dynamic variations in device power availability. As a result, devices with limited or fluctuating energy reserves may be assigned disproportionate routing responsibilities, leading to premature battery depletion and network instability.

Energy-harvesting devices, such as solar-powered sensors, introduce additional complexity. Their power income depends heavily on environmental factors, including device placement, lighting conditions, seasonal variation, obstruction by building structures, and operational schedules (e.g., lights being turned off during non-business hours). Existing networking frameworks generally treat these devices equivalently to battery-powered devices and do not incorporate real-time or historical energy availability into topology formation decisions. This mismatch can cause intermittent outages, node failures, and cascading communication disruptions when intermediate routing nodes lose power.

Current systems also inadequately account for the cumulative power burden imposed by descendant or downstream nodes in hierarchical network structures. In many mesh implementations, a device serving as a relay for multiple other devices incurs additional transmission and reception overhead. Existing routing protocols typically evaluate link cost based on signal metrics (e.g., RSSI, link quality index) or hop count but do not model the incremental energy consumption associated with supporting dependent nodes. Consequently, certain nodes may become overloaded from a throughput perspective, accelerating energy depletion and degrading overall network performance.

Another limitation of present technology lies in simplistic signal modeling. Network formation often relies on empirical signal strength measurements taken during commissioning or assumes uniform propagation characteristics. Obstacles such as walls, floors, ceilings, and structural materials are frequently ignored or treated generically. Variations in material composition, thickness, humidity, angle of incidence, antenna radiation patterns, and multipath interference are not systematically modeled in most low-power network configuration tools. This can result in network topologies that appear feasible during planning but fail under real-world attenuation conditions.

Additionally, existing network formation tools are largely static. They may perform an initial topology optimization at deployment but lack mechanisms for periodic reassessment in response to changing environmental conditions or evolving energy profiles. Energy-harvesting performance can drift over time due to seasonal lighting changes, modifications to interior layouts, installation of new obstacles, or degradation of components. Current approaches do not adequately adapt to these temporal variations, leading to gradual degradation of network reliability.

Conventional routing heuristics also struggle when constraints conflict. For example, minimizing hop count may conflict with preserving node energy reserves. Existing systems typically prioritize a single optimization metric, such as shortest path, without robustly handling multi-constraint trade-offs involving signal feasibility, routing efficiency, and per-node energy capacity. In complex environments with heterogeneous device capabilities, these simplistic heuristics can produce unstable or suboptimal network structures.

Further, Conventional mesh routing protocols assume static power availability and fail to account for variable energy harvesting behavior, resulting in premature device failure and network instability. These failures manifest as physical battery depletion, communication loss, and retransmission storms in low-power wireless hardware systems.

Finally, when network overload conditions occur—such as when aggregate device demand exceeds available relay capacity—current technologies often lack structured mechanisms to detect, quantify, and mitigate the imbalance. Instead, failures manifest as intermittent communication loss, repeated retransmissions, and increased power drain, compounding the underlying problem.

Accordingly, existing low-power networking technologies exhibit deficiencies in energy-awareness, environmental modeling, adaptive topology management, and constraint-based routing optimization. These limitations reduce reliability, shorten device lifetime, and increase maintenance burdens in deployments involving variable energy-harvesting devices.

Various embodiments described herein address deficiencies in existing low-power and energy-harvesting device networks by introducing energy-aware topology formation, environmental signal modeling, and adaptive routing mechanisms that account for heterogeneous and time-varying device power availability.

In contrast to conventional approaches that assume uniform or static power availability, various embodiments incorporate device-specific power income, power consumption, and communication throughput characteristics into network formation decisions. Each device's historical and/or modeled power income is evaluated over a selected time period, and this value is combined with device power consumption and modeled throughput costs to determine an abstracted excess energy metric. From this metric, an allowed number of descendant devices is derived, representing the maximum number of dependent devices that the device can sustainably support without entering a power deficit condition.

By constraining network tree construction based on these allowed descendant limits, various embodiments prevent routing overload of devices with limited or fluctuating energy reserves. Devices that harvest energy from ambient sources such as solar panels are thus assigned routing responsibilities commensurate with their actual energy availability. This reduces premature battery depletion, avoids cascading network failures caused by intermediate relay shutdowns, and extends overall network lifetime.

Various embodiments further improve network reliability by incorporating environmental modeling into signal strength determination. Rather than relying solely on empirical RSSI measurements or simplified propagation assumptions, signal feasibility between device pairs may be estimated using a structural model of the environment. This model may include wall locations, material composition, thickness, resistance values, obstacle geometry, and antenna radiation characteristics. Attenuation through obstacles, angle of incidence effects, refraction, reflection, and multipath interference may be estimated to produce a more accurate expected signal strength between devices.

By using these signal strength determinations to constrain or weight possible communication links, the resulting network topology more closely reflects real-world propagation behavior. This reduces formation of unstable links and improves robustness in environments with complex structural features.

Various embodiments also introduce routing heuristics that balance multiple constraints simultaneously, including hop count, signal strength, and per-device power capacity. Instead of optimizing solely for shortest path or strongest link, the topology generation process evaluates whether a device's entire upstream chain can sustain additional dependent load. Devices may adopt or release neighbors based on whether doing so maintains compliance with allowed descendant limits while preserving efficient paths to a designated root or gateway node. This multi-constraint approach improves network stability in heterogeneous deployments.

In some embodiments, network reorganization is performed periodically or in response to detected changes in device power state, environmental conditions, or error indicators. By recalculating power numbers and reassessing routing assignments, the network adapts to seasonal lighting changes, structural modifications, device relocation, or component degradation. This adaptive behavior maintains network integrity over time without requiring manual reconfiguration.

Additionally, various embodiments provide mechanisms for detecting and managing unsatisfiable network conditions. When aggregate routing demand exceeds available device capacity, the system may distribute load across multiple paths or identify overload conditions for remediation. This structured handling of constraint violations reduces uncontrolled failure modes and improves predictability of network behavior. Specifically, in various embodiments, The determined maximum number of descendant devices directly limits forwarding operations executed by radio hardware, thereby reducing physical energy expenditure during packet transmission and reception cycles.

Through energy-aware descendant allocation, environment-informed signal modeling, multi-constraint routing heuristics, and adaptive topology management, various embodiments enable creation of resilient low-power networks composed of variable energy-harvesting devices. These techniques improve network longevity, reduce maintenance requirements, mitigate intermittent link failures, and enhance overall communication reliability in dynamic physical environments.

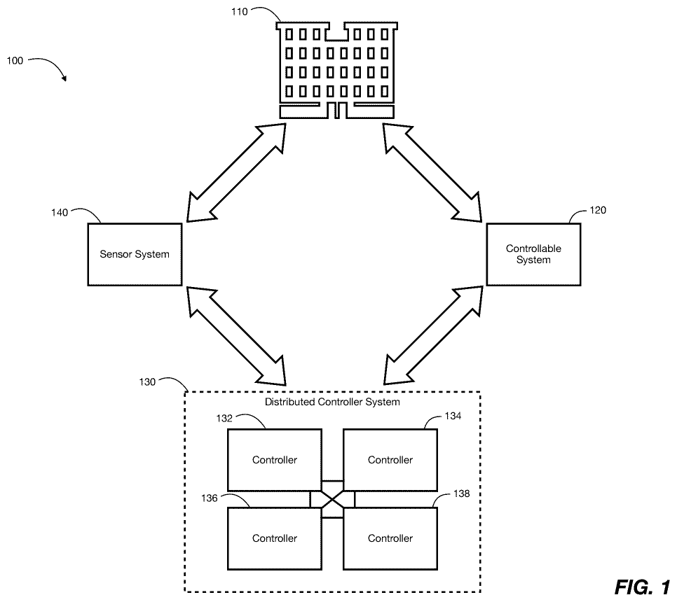

FIG. 1 illustrates an example system 100 for implementation of various embodiments. As shown, the system 100 may include an environment 110, some aspect of which is affected by a controllable system 120. The behavior of the controllable system 120 is, in turn, controlled by a distributed controller system 130. To obtain information useful in making control decisions, the distributed controller system 130 receives data from a sensor system 140 which, in turn, generates its data based on observations from the environment 110.

According to one specific example, system 100 may describe a heating, ventilation, and air conditioning (HVAC) application. As such the environment 110 may be a building whose temperature is to be controlled by the controllable system 120. The controllable system 120 may be the HVAC system itself, which may be controllable to distribute warm or cool air throughout the building 110. Thus, the controllable system 120 may include HVAC equipment such as pumps, boilers, radiators, chillers, fans, vents, etc. The sensor system 140 may include a set of temperature sensors distributed throughout the building 110 to collect and report temperature values.

While various embodiments disclosed herein will be described in the context of such an HVAC application, it will be apparent that the techniques described herein may be applied to other applications including, for example, applications for controlling a lighting system, a security system, an automated irrigation or other agricultural system, a power distribution system, a manufacturing, forestry or other industrial system, or virtually any other system that may be controlled or monitored. Further, the techniques and embodiments may be applied other applications outside the context of controlled systems. Various modifications to adapt the teachings and embodiments to use in such other applications will be apparent.

As shown, the distributed controller system 130 includes four controllers 132, 134, 136, 138 in communication with one another. The controllers 132, 134, 136, 138 may be located within the environment 110, at another location (such as another environment similar to the environment 110 or in a cloud data center), or some combination thereof. Each controller 132, 134, 136, 138 may be connected to one or more devices, such as individual devices of the controllable system 120 or sensor system 140. Such connection may be direct or indirect (e.g., via one or more intermediate devices such as a network), wired or wireless, or any other type of connection that would enable communication between devices. In some embodiments, each controller 132, 134, 136, 138 may be connected to those devices of the controllable system 120 or sensor system 140 that are physically most proximate to that respective controller 132, 134, 136, 138. For example, where the environment 110 is a building with four floors, the controllers 132, 134, 136, 138 may be installed one on each such floor and then connected to the devices of the controllable system 120 or sensor system 140 physically located on the same floor. Alternatively, devices of the controllable system 120 may be distributed amongst controllers 132, 134, 136, 138 via criteria other than physical proximity, such as demand of the devices on the each controller 132, 134, 136, 138.

The controllers 132, 134, 136, 138 may be identical to each other or may employ different hardware or software. For example, two controllers 132, 134 may be full featured controllers while the other two controllers 136, 138 may be satellite controllers with limited capabilities with respect to the full featured controllers. As another example, one or more of the controllers 132, 134, 136, 138 may be specialized in one or more respects, deployed to work on only a subset of tasks associated with controlling the controllable system 120. As such, the controllers 132, 134, 136, 138 may implement partial or full redundancy of functionality or may divide functionality among themselves (either by pre-installation component design or by post-installation coordination or agreement) to achieve a fully functional distributed controller system 130. While the teachings and embodiments disclosed herein will be described with respect to fully-redundant, fully-featured controllers 132, 134, 136, 138 (unless otherwise noted), modifications for applications of the teachings and embodiments for application to such alternative controller 132, 134, 136, 138 arrangements will be apparent. It will also be apparent that other embodiments may include a greater or fewer number of controllers. In some such embodiments, the system 100 may include only a single controller, rather than multiple controllers cooperating in a distributed manner. Various modifications in such alternative embodiments will be apparent.

Various methods for implementing a distributed controller system 130 may be employed for coordinating the functions of the controllers 132, 134, 136, 138. For example, the controllers 132, 134, 136, 138 may coordinate to elect a single controller 132, 134, 136, 138 to take the function of leader controller, while the remaining controllers 132, 134, 136, 138 become follower controllers. In such an arrangement, each follower controller may perform some limited functionality, such as receiving sensor data from those devices in the sensor system 140 attached to that follower controller, committing such sensor data to a database 226 available to the other controllers 132, 134, 136, 138, ensuring proper connections and operation of devices of the controllable system 120 attached to that follower controller, performing fault detection for one or more field devices 296, or calculating derived “sensor” or otherwise predicting data for areas or components where direct observation (e.g., via a physical sensor device) is not possible.

Meanwhile, the elected leader controller may be responsible for additional functionality such as, for example, training machine learning models, running simulations, and making control decisions for the controllable system 120. In some embodiments, the elected leader controller may rely on the remaining controllers 132, 134, 136, 138 to assist in the performance of these tasks by distributing work among the follower controllers according to various distributed work paradigms that may be employed. For example, the leader controller may break a task to be performed into multiple smaller steps or work packages, transmit the steps or work packages to the follower controllers for performance, receive the sub-results of the steps or work packages back when the work is completed, and use the sub-results to arrive at an ultimate result (e.g., a further trained model, a completed simulation or set of simulations, or a control decision). With regard to control decisions or other actions involving communication with devices of the controllable system 120 or the sensor system 140, the leader controller may determine to which of the controllers 132, 134, 136, 138 the device is connected and send the communication to that controller 132, 134, 136, 138 to then be passed on to the intended device.

It will be understood that FIG. 1 may represent a simplification in some respects. For example, in some embodiments, one or more devices may be both a controllable device (belonging to the controllable system 120) and a sensor device (belonging to the sensor system 140). For example, a controllable pump may have an integrated sensor that reports an observed pressure back to the distributed controller system 130. In some embodiments, there may be multiple controllable systems 120, multiple sensor systems 140, or other systems (not shown) involved in implementing the overall system 100, each of which may or may not be in communication with the distributed controller system 130. For example, the distributed controller system 130 may control both an HVAC system and a lighting system, which may be implemented as two independent controllable systems 120. As another example, the distributed controller system 130 may obtain sensor data from both a set of sensors the distributed controller system 130 manages as well as a set of sensors managed by a third party service (e.g., as may be made available through an API or other network-based service) and, as such, there may be multiple independent sensor systems 140 that inform the operation of the distributed controller system 130. In some embodiments, the distributed controller system 130 may manage controllable systems 120 for multiple environments 110 (e.g., the HVAC systems for two or more separate buildings) or may be in communication with other distributed controller systems 130 associated with implementations of systems similar to system 100 for other environments 110 (e.g., to extend the processing capacity through distribution of work to additional controllers, to execute multi-building control actions, or to gather information from other environments such as predicted power usage). Thus, where the environment 110 is a building, one or more distributed controller systems 130 may implement not only a “smart building” but a “smart city” of multiple buildings coordinating their operations. Various modifications for replicating or otherwise adapting the teachings herein across additional environments, controllable systems, distributed controller systems, or sensor systems will be apparent.

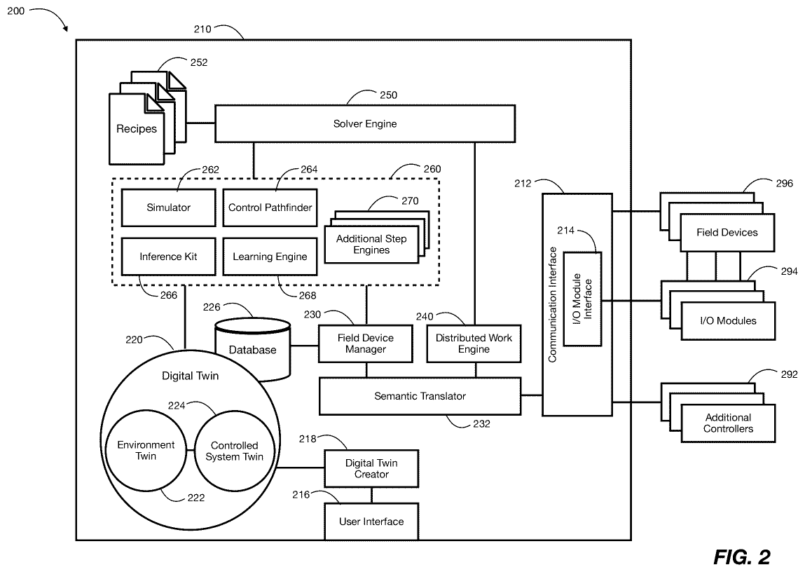

FIG. 2 illustrates an example system 200 for implementing a controller device 210. The controller device 210 may correspond to one of the controllers 132, 134, 136, 138 of the example system 100 and, as such, may communicate with additional controllers 292 (which may correspond to the remaining controllers 132, 134, 136, 138) to implement a distributed controller system such as the distributed controller system 130. In other embodiments, where only a single controller 210 is used, the additional controllers 292 may not be present. In some embodiments, the controller 210 may be or include a building automation system (BAS) or building management system (BMS).

The controller 210 also communicates with multiple field devices 296. These field devices 296 may correspond to one or more devices belonging to the controllable system 120 or sensor system 140 of the example system 100. Similarly, other field devices 296 may communicate with the additional controllers 292. As such, the field devices 296 may include devices that may be controlled to affect some state of an environment (e.g., HVAC equipment that cooperate to manage a building temperature) or sensor devices that report back information about the environment (e.g., temperature sensors deployed among the different environmental zones of the building).

As noted above, virtually any connection medium (or combination of media) may be used to enable communication between the controller 210 and the additional controllers 292 or field devices 296, including wired, wireless, direct, or indirect (i.e., through one or more intermediary devices, such as in a network) connections. As used herein, the term “connected” as used between two devices will be understood to encompass any form of communication capability between those devices. To enable such connections, the controller 210 includes a communications interface 212. As will be explained in greater detail below, the communication interface 212 may include virtually any hardware for enabling connections with additional controllers 292 or field devices 296, such as an Ethernet network interface card (NIC), WiFi NIC, or USB connection.

In some embodiments, one or more connections to other devices may be supported by one or more I/O modules 294. The I/O modules 294 may provide further hardware or software used in controlling or otherwise communicating with field devices 296 having specific protocols or other particulars for such communication to occur. For example, where a field device 296 includes a motor to be controller, an I/O module 294 having components such as a motor control block, motor drivers, pulse width modulation (PWM) control, or other components relevant to motor control may be used to connect that field device 296 to the controller 210. Various additional components for inclusion in different I/O modules 294 for control of different particular field devices 296. Additional features, such as current or voltage monitoring or overcurrent protection may also be incorporated into the I/O modules 294. To enable communication with the I/O modules 294, the communication interface 212 may include an I/O module interface 214. In various embodiments, the I/O module interface 214 may be a set of electrical contacts for contact with complementary pins of the I/O modules 294. A communication protocol, such as USB, may be implemented over such contacts and pins to enable passing of information between the controller 210 and I/O modules 294. In other embodiments, the I/O module interface 294 may include the same interfaces previously described with respect to the communication interface. In various alternative embodiments, on the other hand, some or all of these more particular components may be incorporated into the controller 210 itself, and some or all of the I/O modules 294 may be omitted from the system 200. Various additional techniques for implementing an I/O module 294 according to various embodiments, may be described in U.S. Pat. Nos. 11,229,138; and 11,706,891, the entire disclosures of which are hereby incorporated herein by reference.

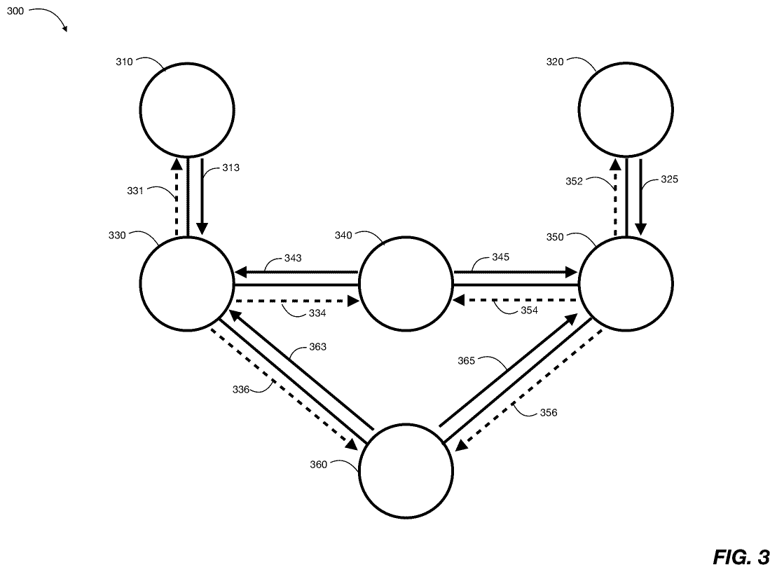

According to various embodiments, the controller 210 utilizes a digital twin 220 that models at least a portion of the system it controls and may be stored in a database 226 along with other data. As shown, the digital twin 220 includes an environment twin 222 that models the environment whose state is being controlled (e.g., a building) and a controlled system twin 224 that models the system that the controller 210 controls (e.g., an HVAC equipment system). A digital twin 220 may be any data structure that models a real-life object, device, system, or other entity. Examples of a digital twin 220 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins. Further, while the environment twin 222 and controlled system twin 224 are shown as separate structures, in various embodiments, these twins 222, 224 may be more fully integrated as a single digital twin 220. In some embodiments, additional systems, entities, devices, processes, or objects may be modeled and included as part of the digital twin 220.

In various embodiments, a user may create or modify the digital twin 220. In such embodiments, the controller 210 may include a user interface 216 through which the user accesses a digital twin creator 218 to create or modify the digital twin 220. For example, the user interface 216 may include a display, a touchscreen, a keyboard, a mouse, or any device capable of performing input or output functions for a user. In some embodiments, the user interface 216 may instead or additionally allow a user to use another device for such input or output functions, such as connecting a separate tablet, mobile phone, or other device for interacting with the controller 210.

The digital twin creator 218 may provide a toolkit for the user to create digital twins 220 or portions thereof. For example, the digital twin creator 218 may include a tool for defining the walls, doors, windows, floors, ventilation layout, and other aspects of a building construction to create the environment twin 222. The tool may allow for definition of properties useful in defining a digital twin 220 (e.g., for running a physics simulation using the digital twin 220) such as, for example, the materials, dimensions, or thermal characteristics of elements such as walls and windows. Such a tool may resemble a computer-aided drafting (CAD) environment in many respects. According to various embodiments, unlike typical CAD tools, the digital twin creator 218 may digest the defined building structure into a digital twin 220 model that may be computable, trainable, inferenceable, and queryable, as will be described in greater detail below.

In addition or alternative to building structure, the digital twin creator 218 may provide a toolkit for defining virtually any system that may be modeled by the digital twin 220. For example, for creating the controlled system twin 224, the digital twin creator 218 may provide a drag-and-drop interface where various HVAC equipment (e.g., boilers, pumps, valves, tanks, etc.) may be placed and connected to each other, forming a system (or a group of systems) that reflect the real world controllable system 120. In some embodiments, the digital twin creator 218 may drill even further down into definition of twin elements by, for example, allowing the user to define individual pieces of equipment (along with their behaviors and properties) that may be used in the definition of systems. As such, the digital twin creator 218 provides for a composable twin, where individual elements may be “clicked” together to model higher order equipment and systems, which may then be further “clicked” together with other elements.

In other embodiments, the digital twin 220 may be created by another device (e.g., by a server providing a web-or other software-as-a-service (SaaS) interface for the user to create the digital twin 220, or by a device of the user running such software locally) and later downloaded to or otherwise synced to the controller 210. In other embodiments, the digital twin 220 may be created automatically by the controller 210 through observation of the systems it controls or is otherwise in communication with. In some embodiments a combination of such techniques may be employed to produce an accurate digital twin—a first user may initially create a digital twin 220 using a SaaS service, the digital twin 220 may be downloaded to the controller 210 where a second user further refines or extends the digital twin 220 using the digital twin creator 218, and the controller 210 in operation may adjust the digital twin 220 as needed to better reflect the real observations from the systems it communicates with. Various additional techniques for defining, digesting, compiling, and utilizing a digital twin 220 according to some embodiments may be described in U.S. Pat. Nos. 10,708,078; and 10,845,771; and U.S. patent application publication numbers 2021/0383200; 2021/0383235; and 2022/0215264, the entire disclosures of which are hereby incorporated herein by reference.

In addition to storing the digital twin 220, the database 226 may store additional information that is used by the controller 210 to perform its functions. For example, the database 226 may hold tables that store sensor data collected from field devices 296 or control actions that should be issued to field devices 296. Various additional or alternative information for storage in the database 226 will be apparent. In various embodiments, the database 226 implements database replication techniques to ensure that the database 226 content is made available to the additional controllers 292. As such, changes that the controller 210 makes to the database 226 content (including the digital twin 220) may be made available to each of the controllers 292, while database changes made by the additional controllers 292 are similarly made available in the database 226 of the controller 210 as well as the other additional controllers 292.

A field device manager 230 may be responsible for initiating and processing communications with field devices 296, whether via I/O modules 294 or not. As such the field device manager 230 may implement multiple functions. For sensor management, the device manager 230 may receive (via the communication interface 212 and semantic translator 232) reports of sensed data. The field device manager 230 may then process these reports and place the sensed data in the database 226 such that it is available to the other components of the controller 210. In managing sensor devices, the field device manager 230 may be configured to initiate communications with the sensor devices to, for example, establish a reporting schedule for the sensor devices and, where the sensor devices form a network for enabling such communications, the network paths that each sensor device will use for these communications. In some embodiments, the field device manager 230 may receive (e.g., as part of sensor device reports) information about the sensor health and then use this information to adjust reporting schedule or the network topology. For example, where a sensor device reports low battery or low power income, the controller 210 may instruct that sensor device to report less frequently or to move to a leaf node of the network topology so that its power is not used to perform the function of routing messages for other sensors with a better power state. Various other techniques for managing a group or swarm of sensor devices will be apparent.

The field device manager 230 may also be responsible for managing and verify the connections of field devices 296 to the I/O modules 294. For example, configuration data stored in the digital twin 220 or elsewhere in the database 226 may indicate that a particular field device 296 is expected to be connected to a particular I/O module 294 having a particular set of supporting components, that the particular I/O module 294 is expected to be connected to a particular I/O module interface 214, and that communications through the particular I/O module 294 are expected to occur according to a particular set of protocols. The field device manager 230 may test (e.g., by sending one or more test communications) that the particular field device 296 is actually set up according to these configurations (e.g., if communications are successful or not) and then take remedial action if there is an installation problem. In some cases, the field device manager 230 may simply update the configuration information if doing so will solve the incorrect installation (e.g. the I/O module 294 is connected to a different I/O module interface 214 but is otherwise working, the I/O module 294 is configured to communicate according to a different protocol). In other cases, the field device manager 230 may prompt a user that these is an issue with the connection and ask for the user to take remedial action (e.g., reconfigure settings at the controller 210 or physically relocate, replace, or otherwise reinstall an I/O module 294, connection wires, or the field device 296). As such, the field device manager 230 in some embodiments provides a software toolset for the user via the user interface 216, a web portal, or elsewhere. In some embodiments, such a user interface 216 may be a graphical representation of the controller 210, I/O modules 294, and field device 296 connections thereto that allows the user to see how these devices are expected by the controller 210 to be installed. In some embodiments, the toolset may also allow the user to reconfigure these expectations rather than physically changing the system of devices (e.g., by dragging an I/O module graphic to a different connection graphic, or by changing a connection type for one or more wiring terminal graphics of an I/O module graphic).

In some embodiments, in addition to the verification of I/O module 294 connections, the field device manager 230 may perform a fuller commissioning procedure. For example, the field device manager 230 may perform a series of tests on the field devices 296 that are connected to the controller 210 or on the full set of field devices 296 in the controllable system 120 or the sensor system 140 (particularly where the controller 210 has been elected as a leader controller). Accordingly, in some such embodiments, the field device manager 230 may communicate with the field devices 296 via the communication interface 212 to perform tests to verify that installation and behavior is as expected (e.g., as expected from simulations run against the digital twin 220 or from other configurations stored in the database 226 or otherwise available to the controller 210). Where the field device manager 230 drives testing of field devices 296 attached instead to one or more additional controllers 292, the testing may include communication with the additional controllers 292 (e.g., through use of the distributed work engine 240 or directly through the communications interface 212), such as test messages that the additional controllers 292 route to their connected field devices 296 or instructions for the additional controllers 292 to perform testing themselves and report results thereof.

In some embodiments, the testing performed by the field device manager 230 may be defined in a series of scripts, preprogrammed algorithms, or driven by artificial intelligence (examples of which will be explained below). Such tests may be very simple (e.g., “can a signal be read on a wire,” or “does the device respond to a simple ping message”), device specific (e.g., “is the device reporting errors according to its own testing,” “is the device reporting meaningful data,” “does the device successfully perform a test associated with its device type”), driven by the digital twin 220 (“does this device report expected data or performance when this other equipment is controlled in this way,” “when the device is controlled this way, do other devices report expected data”), at a higher system level (“does this zone of the building operate as expected,” “do these two devices work together without error”), or may have any other characteristics for verifying proper installation and functioning of a number of devices both individually and as part of higher order systems.

In some embodiments, a user may be able to define (e.g., via the user interface 216) at least some of the commissioning tests to be performed. In some embodiments, the field device manager 230 presents a graphical user interface (GUI) (e.g., via the user interface 216) for giving a user insight into the commissioning procedures of the field device manager 230. Such a GUI may provide an interface for selecting or otherwise defining testing procedures to be performed, a button or other selector for allowing a user to instruct the field device manager 230 to begin a commissioning process, an interface showing the status of an ongoing commissioning process, or a report of a completed commissioning process along with identification of which field devices 296 passed or failed commissioning, recommendations for fixing failures, or other useful statistics.

In some embodiments, the data generated by a commissioning process may be useful to further train the digital twin 220. For example, if activating a heating radiator does not cool a room as much as expected, there may be a draft or open window in the room that was not originally accounted for that can now be trained intro the digital twin 220 for improved performance. As such, in some embodiments, the field device manager 230 may log the commissioning data in a form useful for the learning engine 268 to train the digital twin 220, as will be explained in greater detail below.

In some embodiments, the field device manager 230 may also play a role in networking. For example, the field device manager 230 may monitor the health of the network formed between the controller 210 and the additional controllers 292 by, for example, periodically initiating test packets to be sent among the additional controllers 292 and reported back, thereby identifying when one or more additional controllers 292 are no longer reachable due to, e.g., a device malfunction, a device being turned off, or a network link going down. In a case where one of the additional controllers 292 had been elected leader, the field device manager 230 may call for a new leader election among the remaining reachable additional controllers 292 and then proceed to participate in the election according to any of various possible techniques.

With respect to runtime control of the field devices 296, while other components (such as the control pathfinder 264) may decide what control actions are to be taken and make them available to other components (e.g., by writing the desired actions to the database 226), the field device manager 230 may be responsible for issuing the commands to the field devices 296 that cause the desired action to occur. In some embodiments, where the controller 210 is elected leader controller, the field device manager 230 may issue commands not only to the field devices 296 connected to the controller 210 but also to the additional controllers 292. In other embodiments where the database 226 is available to multiple controllers 210, 292 (e.g., through database replication techniques, by allowing the additional controllers 292 to query the database 226 of the controller 210, or by making the database 226 available on a different accessible server) the respective field device managers 230 or analogous components of the additional controllers 292 may similarly notice updates to the desired control actions and issue commands to their respective attached field devices 296 to effect the desired controls. Various additional techniques for implementing a field device manager 230 according to various embodiments may be described in U.S. Pat. Nos. 11,477,905; 11,596,079; and U.S. patent application publication numbers 2022/0067226; 2022/0067227; 2022/0067230; and 2022/0070293, the entire disclosures of which are hereby incorporated herein by reference.

Various embodiments utilize a higher order language to direct operations internal to the controller 210 and additional controllers 292. As an example, while field devices 296 may be controlled or otherwise communicate according to various diverse semantics and protocols (e.g., BACnet, Modbus, Wirepas, Pulse-Width Modulation, Frequency Modulation, 1-Wire, Bluetooth Low Energy Mesh, Ethernet, WiFi, 24VAC, Voltage signal, Current signal, Resistance signal, the higher order language itself, etc.), desired actions identified by the control pathfinder 264, written to the database 226, or issued by the field device manager 230 may be agnostic to these particular differences. As another example, while the actions that the field devices 296 can perform may be differentiated based on the characteristics of a device (a pump can be instructed to pump fluid, a fan can be instructed to spin), these actions may be abstracted (or semantically raised) into the same action (either of these devices may be instructed to cause quanta to move). Thus, when a BACnet pump is to be instructed to begin pumping fluid, rather than issuing a specific BACNet command that will activate that pump or issuing an instruction for the pump to begin pumping, the field device manager 230 may issue a command that the particular “transport” field device 296 begin to move quanta from its input to its output. Such a higher order language may be reflective of the high order at which the digital twin 220 is defined, as will be explained in greater detail below.

While some field devices 296 may natively understand the higher order language, others may still require communication according to their own native protocols. A semantic translator 232 may thus be responsible for translating higher order language communications received from the field device manager 230 or distributed work engine 240 into the appropriate lower level, protocol specific messages that will be sent via the communication interface 212. So, where the field device manager 230 issues a command for a particular transport field device 296 to begin moving quanta, the semantic translator 232 may semantically lower this command to a command for a pump to begin pumping fluid (or for a fan to begin spinning, etc., depending on the specifics of the device as may be defined in the digital twin 220) and then semantically translate this command to a BACnet message (or Modbus, etc., depending on the specifics of the device as may be defined in the digital twin 220) that will accomplish the lowered action. The semantic translator 232 may then transmit the fully-formed message to the appropriate recipient device via the communications interface 212. Thus, while the digital twin 220 and other internal components of the controller 210, may operate according to a semantically-raised language (which may be driven by a semantic ontology used in the digital twin 220), the digital twin 220 may additionally store information for the various field devices 296 useful in semantically lowering and translating this language to enable effective communication with the field devices 296. In various embodiments, the semantic translator 232 may work in the opposite direction as well, translating and raising incoming messages from the field devices 296, such that they may be interpreted and acted on according to the semantically raised language of the controller 210. Various techniques for implementing a semantic translator 232, a digital twin 220 ontology, or an internal semantically-raised language according to some embodiments may be disclosed in U.S. patent application publication numbers 2022/0066754; and 2022/0066761, the entire disclosures of which are incorporated herein by reference.

As shown, the controller 210 includes a distributed work engine 240 for guiding the distributed operation of the controller 210 with additional controllers 292. As such, the distributed work engine 240 may receive computation steps (e.g., from the solver engine 250) to be outsourced to other controllers 292, transmit the work (via the semantic translator 232 or communication interface 292) to the additional controllers 292, receive work results back, and pass them back to the solver engine 250. Such a workflow may be used when, for example, the controller 210 has been elected as a leader controller. The distributed work engine 240 may also implement the other side by receiving work requests from one or more additional controllers 292, passing the work requests to the solver engine 250 or directly to a step engine 260, receiving the result of the work, and transmitting the result back to the requesting controller 292. Such a workflow may be used when, for example, the controller 210 has been not elected as a leader controller and is, instead, a follower controller. In various alternative embodiments, the controller 210 may both issue work requests to other controllers 292 and execute work requests received from additional controllers 292, regardless of status as a leader or follower (if any). The distributed work engine 240 may perform additional functionality associated with managing a distributed compute system such as, for example, selecting particular ones of the additional controllers 292 to receive particular work requests, receiving load metrics or otherwise assessing compute health/capacity of the additional controllers 292, performing load balancing among the additional controllers 292, and deciding when to resend or reassign previously issued work requests, and when to time out previously issued work requests (too much time has elapsed, a sufficient number of other responses have been received, etc.) and instruct the solver engine 250 to move on with the next steps of a computation. Various additional techniques for implementing a distributed work engine 240 according to some embodiments may be described in U.S. Pat. No. 11,490,537, the entire disclosure of which is hereby incorporated herein by reference.

A solver engine 250 may be responsible for driving many, if not all, of the higher order functions of the controller 210 such as, for example, running simulations, deciding on control actions to be taken, causing the digital twin 220 to learn from observations, etc. To effect such actions, the solver engine 250 may execute various recipes 252 (which may be stored in the database 226 or elsewhere) that define a sequence of steps to be performed by separate step engines 260. Accordingly, the solver engine 250 may identify a recipe to be executed (e.g., based on manual selection of a recipe 252 for execution by a user, invocation of a recipe 252 by step engine 260, identification by the step of another recipe 252 under execution, a scheduled time for a recipe 252, a timer elapsing since the past execution of the recipe 252, or the occurrence of some trigger event associated with the recipe 252). The solver engine 250 may then begin to “walk through” the steps of the recipe 252, identifying an appropriate step engine 260 to perform the step, issuing the step to that step engine 260, receiving the result after the step engine 260 has completed its work, and then move on to the next step of the recipe 252. In some embodiments, the solver engine 250 may itself be adapted to perform some steps. The solver engine 250 may then iterate on this process until it reaches the end of the recipe 252.

In some cases, the solver engine 250 may decide that one or more steps of a recipe 252 are to be outsourced to another controller 292. For example, the recipe 252 itself may specify that a step is to be performed by another controller 292, the solver engine 250 may determine that local processing capacity is not sufficient to perform a step, or the solver engine may encounter multiple parallel steps in a recipe 252 and decide to perform only one or a subset locally while outsourcing the rest.

The step engines 260 may include a number of varying functions that can be relied on by the recipes 252 and solver engine 250 to perform various steps of a larger task. As shown, the step engines 260 include a simulator 262, a control pathfinder 264, and inference kit 266, a learning engine 268, and one or more additional step engines 270. It will be apparent that fewer, additional, or different step engines 270 may be included depending on the functions to be performed by the controller 210 (e.g., as may be defined in the recipes 252) and as appropriate to adapting the controller 210 for use in different applications.

The simulator 262 may be configured to simulate the behavior of the system 100 into the future or under alternative/hypothesis conditions. To accomplish such a simulation, the simulator 262 may execute a sequence of time steps (e.g., simulating the state of the digital twin 220 a minute into the future at a time) until the future time is reached and state can be read from the digital twin 220. For example, to simulate the temperature of a zone one hour into the future, the simulator 262 may propagate heat from all heat sources through the digital twin 220 one minute at a time, sixty times, and then read the temperature of the zone from the digital twin 220. The use of the digital twin 220 to perform such simulations will be explained in greater detail below. In various embodiments, the simulator 262 may actually encompass multiple more specific simulator step engines. For example, the simulator 262 may include separate simulators for simulating state of the building, operating of equipment, occupancy of different zones of the building, and the impact of weather or other external factors on the state of the system 100. The simulator 262 (or other step engines 260) may make use of the digital twin in different manners. In some cases, the simulator 262 may retrieve a precompiled (e.g., at the time of initial digital twin creation) digital twin 220, place it in memory, populate relevant data into it, and use the data that is produced as simulation output. In other cases, the simulator 262 may alter portions of the digital twin 220 description at the time of simulation (e.g., adding or removing equipment, or changing equipment parameters), compile the digital twin at that point in time, place the newly-compiled twin in memory, and then run its simulation. Thus, the digital twin 220 may include both a data description of the systems being modeled as well as compiled and functional versions of that data description.

The control pathfinder 264 may be configured to identify, using the digital twin 220, one or more control actions to be performed be the field devices 296 to reach a desired state. For example, the control pathfinder 264 may analyze multiple possible candidate control schemes against the digital twin 220 to determine which candidate control scheme best produces the desired state in the digital twin 220 and then write the control actions from that scheme to the database 226 for the field device manager 230 to act on. In some embodiments, the control pathfinder 264 may leverage the simulator 262 to perform its task (and likewise, step engines 260 may in some embodiments generally invoke each other when useful to the performance of their task).

In other embodiments, the control pathfinder 264 may utilize auto-differentiation and gradient descent to identify an appropriate control scheme to reach a desired state in the digital twin 220. As will be explained in greater detail below, through auto-differentiation, the digital twin 220 may be established as omnidirectional; that is, while activation functions may be defined or learned in a forward direction, their partial derivatives may be used to define “activation functions” in the reverse direction, thereby enabling traversal of the digital twin 220 in any direction and along any path desired. When paired with differentiable programming to define the digital twin 220 (particularly, its activation functions), such partial derivatives may be made available in the digital twin 220 with little-to-no additional compute cost. From here, the control pathfinder 264 may generate a cost function on the digital twin 220 that relates a set of input variables (e.g., possible control variables) to a cost-the distance between the predicted state values and the desired state values. The control pathfinder 264 may then employ gradient descent to identify a control scheme likely to produce the desired state in the environment 110 (or a state acceptably close to the desired state).

Various additional, alternative, or modified methods may be used by the control pathfinder 264 to locate a control path. For example, in some embodiments, the control pathfinder 264 may employ multiple gradient descent agents (e.g., as a Self-Organizing Migrating Algorithm or SOMA) to improve the likelihood of locating a global minimum of the cost function, rather than a local minimum representing a sub-optimal solution control scheme. In some embodiments, a simpler neural network trained against the digital twin 220 for a reduced problem may be used by the control pathfinder 264 to find a control scheme quickly which is then tested and refined against the digital twin 220 or written directly to the database so that the field devices 296 may be controlled immediately. In some embodiments, the control pathfinder 264 may employ more than one of these and other approaches in an ensemble or adversarial approach to find optimal control schemes. Various additional techniques that may be used in implementing a simulator 262, control pathfinder 264, other step engines 260, or other aspects of the controller 210 according to some embodiments may be described in U.S. Pat. Nos. 10,705,492; 10,921,760; U.S. patent application publication numbers 2021/0381712; 2021/0382445; 2021/0383042; and 2021/0383219, the entire disclosures of which are hereby incorporated herein by reference.

The inference kit 266 may be configured to draw information from the digital twin 220 for use in driving decisions. As such, the inference kit 266 may enable reading of values from the digital twin 220 and transformation of such values into derived properties and other values (e.g., reading heat and humidity values and sending them through a transformation to produce a comfort value). In various embodiments, the inference kit 266 may provide more advanced inferencing such as performing sensor fusion and defining “virtual sensors” to enable simulation of additional state values at locations where there are not sensors in the real world system 100 from which to draw information. Various techniques for implementing an inference kit 266 according to some embodiments may be disclosed in U.S. patent application publication number 2021/0383236, the entire disclosure of which is hereby incorporated herein by reference.

The learning engine 268 may be configured to train machine learning models for the benefit of the controller 210. For example, in various embodiments, the digital twin 220 itself is trainable. As such, the learning engine 268 may periodically use one or more training examples and machine learning approaches (such as supervised learning and gradient descent) to train the digital twin's 220 activation functions to better model the observed real world system. Such training examples may be drawn from the database 226 (e.g., from sensor data placed there by the field device manager 230 or additional controllers 292). In some embodiments, the learning engine 268 may train additional neural networks, deep learning networks, or other machine learning models based on the simulations (e.g., as may be run by the simulator 262). As such, the learning engine 268 may include a training archivist that captures simulated cases during execution of a recipe 252 and stores them as training examples in the database 226. The learning engine 268 may later used these training examples to train these simple models for later use. Thus, in various embodiments, the learning engine 268 trains the digital twin 220 based on real world observed data and then trains simple models based on the operation of the digital twin 220. Various additional techniques for implementing a learning engine 268 according to some embodiments may be disclosed in U.S. patent application publication number 2021/0383041, the entire disclosure of which is hereby incorporated by reference herein.

As noted, the step engines 260 may include additional step engines 270 as appropriate to the recipes 252 and application of the controller 210. For example, the additional step engines 270 may include an ontological reasoner (which may use various techniques to simplify the digital twin 220 to only those portions relevant to a particular task, thereby reducing processing resources needed), an occupant process (which may take into account occupant comfort needs or desires to guide the determination of a desired state in a system), a weather process (which may make or otherwise obtain weather forecasts), and other engines. Various additional step engines 270 that may be useful will be apparent. Various additional techniques for implementing such additional step engines 270 according to some embodiments may be described in in U.S. Pat. Nos. 10,969,133; and 11,553,618, the entire disclosures of which are hereby incorporated herein by reference.

It will be apparent that, while particular components are shown connected to one another, this may be a simplification in some regards. For example, components that are not shown as connected may nonetheless interact. For example, the user interface 216 may provide a user with some access to the recipes 252 or field device manage 230. Furthermore, in various embodiments, additional components may be included and some illustrated components may be omitted. In various embodiments, various components may be implemented in hardware, software, or a combination thereof. For example, the communications interface 212 may be a combination of communications protocol software, wired terminals, a radio transmitter/receiver, and other electronics supporting the functions thereof. As another example, the solver engine 250 and step engines 260 may be implemented as software running on a processor (not shown) of the controller 210, while the digital twin 220 may be a data structure stored in the database 226 which, in turn, may include memory chips and software for managing database organization and access. Various other implementation details will be apparent and various techniques for implementing a controller 210 and various components thereof according to some embodiments may be described in U.S. patent application publication numbers 2022/0066432; 2022/0066722; U.S. provisional patent application Nos. 62/518,497; 62/704,976; and 63/070,460 the entire disclosures of which are hereby incorporated herein by reference.

It will be further apparent that various techniques described herein may be utilized in contexts outside of controller devices. For example, various techniques may be adapted to project planning tools, report generation, reporting dashboards, simulation software, modeling software, computer aided drafting (CAD) tools, predictive maintenance, performance optimization tools, or other applications. Various modifications for adaptation of such techniques to other applications and domains will be apparent.

FIG. 3 illustrates an example digital twin 300 for use in various embodiments. The digital twin 300 may correspond, for example, to the digital twin 220, the environment twin 222, or the controlled system twin 224 of FIG. 2. As shown, the digital twin 300 includes a number of nodes 310, 320, 330, 340, 350, 360 connected to each other via edges. As such, the digital twin 300 may be arranged as a graph, such as a neural network. In various alternative embodiments, other arrangements may be used. Further, while the digital twin 30a may reside in storage as a graph type data structure, it will be understood that various alternative data structures may be used for the storage of a digital twin 300 as described herein. The nodes 310, 320, 330, 340, 350, 360 may correspond, for example, to aspects of the environment 110 such as HVAC zones, walls, windows, external forces (such as weather); aspects of the sensor system 130 such as individual sensors; aspects of the controllable system 120 such as controllable HVAC equipment; virtual entities, such as HVAC zone subdivisions or virtual sensors that may be assigned values through sensor fusion; or other aspects that may be used in a simulation. The edges between the nodes 310, 320, 330, 340, 350, 36a may, then, represent some relationship between the system aspects represented by the nodes 310, 320, 330, 340, 350, 360; an edge may represent, for example, physical proximity or relative location, proximity or relative location within a control loop of a system, or another relationship.

According to various embodiments, the digital twin 300 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 300, on the other hand, may include a set of activation functions 313, 325, 343, 345, 363, 365 that are, even before any training or learning, differentiated from each other, i.e., heterogenous. In various embodiments, the activation functions 313, 325, 343, 345, 363, 365 may be assigned based on domain knowledge related to the system being modeled. For example, the activation functions 313, 325, 343, 345, 363, 365 may include appropriate heat transfer functions for simulating the propagation of heat through a physical environment (such as function describing the radiation of heat from or through a wall of particular material and dimensions to a zone of particular dimensions). As another example, activation functions 313, 325, 343, 345, 363, 365 may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 310, 320, 330, 340, 350, 360. In some embodiments, each of the activation functions 313, 325, 343, 345, 363, 365 may in fact include multiple separate functions; such an implementation may be useful when more than one aspect of a system may be modeled from node-to-node. For example, each of the activation functions 313, 325, 343, 345, 363, 365 may include a first activation function for modeling heat propagation and a second activation function for modeling humidity propagation. In some embodiments, these diverse activation functions along a single edge may be defined in opposite directions. For example, a heat propagation function may be defined from node 310 to node 330, while a humidity propagation function may be defined from node 330 to node 310. In some embodiments, the diversity of activation functions may differ from edge to edge. For example, one activation function 313 may include only a heat propagation function, another activation function 343 may include only a humidity propagation function, and yet another activation function 363 may include both a heat propagation function and a humidity propagation function.

According to various embodiments, the digital twin 300 is an omnidirectional neural network. Typical neural networks are unidirectional-they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 300, on the other hand, may include activation functions along both directions of each edge: the previously discussed “forward” activation functions 313, 325, 343, 345, 363, 365 (shown as solid arrows) as well as a set of “backward” activation functions 331, 334, 336, 352, 354, 356 (shown as dashed arrows).

In some embodiments, at least some of the backward activation functions 331, 334, 336, 352, 354, 356 may be defined in the same way as described for the forward activation functions 313, 325, 343, 345, 363, 365—based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the backward activation functions 331, 334, 336, 352, 354, 356 are derived using automatic differentiation techniques. Specifically, according to some embodiments, reverse mode automatic differentiation is used to compute the partial derivative of a forward activation function 313, 325, 343, 345, 363, 365 in the reverse direction. This partial derivative may then be used to traverse the graph in the opposite direction of that forward activation function 313, 325, 343, 345, 363, 365. Thus, for example, while the forward activation function 313 may be defined based on domain knowledge and allow traversal (e.g., state propagation as part of a simulation) from node 310 to node 330 in linear space, the reverse activation function 331 may be defined as a partial derivative computed from that forward activation function 313 and may allow traversal from node 330 to 310 in the derivative space. In this manner, traversal from any one node to any other node is enabled-for example, the graph may be traversed (e.g. state may be propagated) from node 340 to node 310, first through a forward activation function 343, through node 330, then through a backward activation function 331. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontologically labeled neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 300, on the other hand, may ascribe meaning to each of the nodes 310, 320, 330, 340, 350, 360 and edges therebetween by way of an ontology. For example, the ontology may define each of the concepts relevant to a particular system being modeled by the digital twin 300 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the ontology may define producer, consumer, transformer, and other actors for ascribing to nodes) that operate on “quanta” (e.g., the ontology may define fluid, thermal, mechanical, and other quanta for propagation through the model) passing through the system. Additional aspects of the ontology may allow for definition of behaviors and properties for the actors and quanta that serve to account for the relevant specifics of the object or entity being modeled. For example, through the assignment of behaviors and properties, the functional difference between one “transport” actor and another “transport” actor can be captured.

The above techniques, alone or in combination, may enable a fully-featured and robust digital twin 300, suitable for many purposes including system simulation and control path finding. The digital twin 300 may be computable and trainable like a neural network, queryable like a database, introspectable like a semantic graph, and callable like an API.

As described above, the digital twin 300 may be traversed in any direction by application of activation functions along each edge. Thus, just like a typical feedforward neural network, information can be propagated from input node(s) to output node(s). The difference is that the input and output nodes may be specifically selected on the digital twin 300 based on the question being asked, and may differ from question to question. In some embodiments, the computation may occur iteratively over a sequence of timesteps to simulate over a period of time. For example, the digital twin 300 and activation functions may be set at a particular timestep (e.g., 1 minute), such that each propagation of state simulates the changes that occur over that period of time. Thus, to simulate longer period of time or point in time further in the future (e.g., one minute), the same computation may be performed until a number of timesteps equaling the period of time have been simulated (e.g., 60 one second time steps to simulate a full minute). The relevant state over time may be captured after each iteration to produce a value curve (e.g., the predicted temperature curve at node 310 over the course of a minute) or a single value may be read after the iteration is complete (e.g., the predicted temperature at node 310 after a minute has passed). The digital twin 300 may also be inferenceable by, for example, attaching additional nodes at particular locations such that they obtain information during computation that can then be read as output (or as an intermediate value as described below).

While the forward activation functions 313, 325, 343, 345, 363, 365 may be initially set based on domain knowledge, in some embodiments training data along with a training algorithm may be used to further tune the forward activation functions 313, 325, 343, 345, 363, 365 or the backward activation functions 331, 334, 336, 352, 354, 356 to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 300 (e.g., in a lab setting based on a generic training data set) or as a learning process when the digital twin 300 has been deployed for the system it will model. To create training data for active-deployment learning, the controller 210 may observe the data made available from the real-world system being modeled (e.g., as may be provided by a sensor system 140) and log this information as a ground truth for use in training examples. To train the digital twin 300, the controller 210 may use any of various optimization or supervised learning techniques, such as a gradient descent algorithm that tunes coefficients associated with the forward activation functions 313, 325, 343, 345, 363, 365 or the backward activation functions 331, 334, 336, 352, 354, 356. The training may occur from time to time, on a scheduled basis, after gathering of a set of new training data of a particular size, in response to determining that one or more nodes or the entire system is not performing adequately (e.g., an error associated with one or more nodes 310, 320, 330, 340, 350, 360 passed a threshold or passes that threshold for a particular duration of time), in response to manual request from a user, or based on any other trigger. In this way, the digital twin 300 may be adapted to better adapt its operation to the real world operation of the systems it models, both initially and over the lifetime of its deployment, by tacking itself to the observed operation of those systems.

The digital twin 300 may be introspectable. That is, the state, behaviors, and properties of the nodes 310, 320, 330, 340, 350, 360 may be read by another program or a user. This functionality is facilitated by association of each node 310, 320, 330, 340, 350, 360 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 310, 320, 330, 340, 350, 360 can easily be interpreted. If an internal “temperature” property is read from node 310, it can be interpreted as the anticipated temperature of the system aspect associated with that node 310.

Through attachment of a semantic ontology, as described above, the introspectability can be extended to make the digital twin 300 queryable. That is, ontology can be used as a query language usable to specify what information is desired to be read from the digital twin 300. For example, a query may be constructed to “read all temperatures from zones having a volume larger than 200 square feet and an occupancy of at least 1.” A process for querying the digital twin 300 may then be able to locate all nodes 310, 320, 330, 340, 350, 360 representing zones that having properties matching the volume and occupancy criteria, and then read out the temperature properties of each. The digital twin 300 may then additionally be callable like an API through such processes. With the ability to query and inference, canned transactions can be generated an made available to other processes that aren't designed to be familiar with the inner workings of the digital twin 300. For example, an “average zone temperature” API function could be defined and made available for other elements of the controller 210 or even external devices to make use of. In some embodiments, further transformation of the data could be baked into such canned functions. For example, in some embodiments, the digital twin 300 itself may not itself keep track of a “comfort” value, which may defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 300 is merely an example of a possible embodiment and that many variations may be employed. In some embodiments, the number and arrangements of the nodes 310, 320, 330, 340, 350, 360 and edges therebetween may be different, either based on the controller implementation or based on the system being modeled by each deployment of the controller 210. For example, a controller deployed in one building may have a digital twin 300 organized one way to reflect that building and its systems while a controller deployed in a different building may have a digital twin 300 organized in an entirely different way because the building and its systems are different from the first building and therefore dictate a different model. Further, various embodiments of the techniques described herein may use alternative types of digital twins. For example, in some embodiments, the digital twin 300 may not be organized as a neural network and may, instead, be arranged as another type of model for one or more components of the system 100. In some such embodiments, the digital twin 300 may be a database or other data structure that simply stores descriptions of the system aspects, environmental features, or devices being modeled, such that other software has access to data representative of the real world objects and entities, or their respective arrangements, as the software performs its functions.

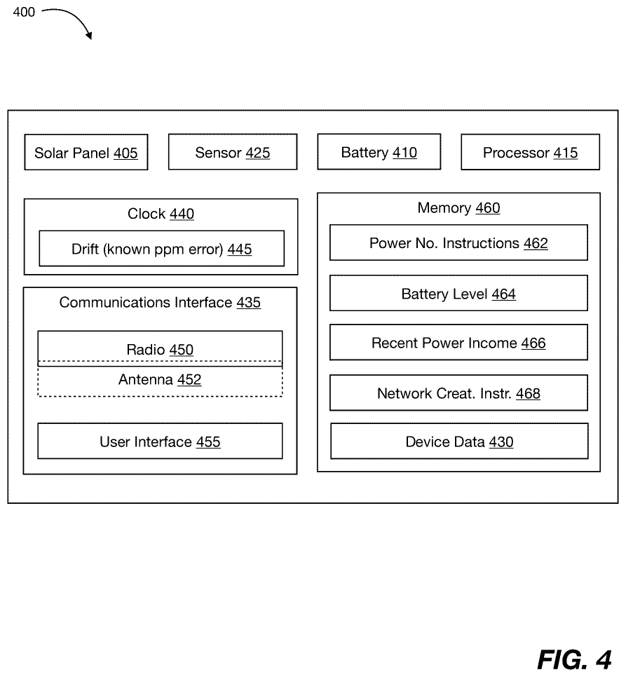

FIG. 4 discloses a block diagram embodiment 400 of a device that may be used with embodiments disclosed herein. Such a device 400 may be part of a sensor system 140, a controllable system 120, etc. This device may be a variable power device equipped with a solar panel that captures sunlight and converts it into electrical energy. The solar panel may be based on various types of photovoltaic technologies, such as monocrystalline, polycrystalline, amorphous, thin-film solar cells or a different sort of solar panel. The solar panel 405 may have energy independence. The solar panel 405 may have an unwired light specification of 50 Lux at 8 hours, 40 Lux at 8 hours, 25 Lux at 8 hours, or a different specification. The energy collected by the solar panel is used to charge a rechargeable battery 410. The rechargeable battery stores the energy collected from the solar panel. This battery provides power to the sensor when harvestable ambient light is not available, such as when lights are turned off, during nighttime or in cloudy conditions. This battery may have battery autonomy. This autonomy may be 1 year with no light, 2 years with no light, or a different specification.

The device can be equipped with one or more sensors 425 that enable it to collect internal and sensor readings. These sensors encompass various types, including air temperature, radiant temperature, atmospheric pressure, sound pressure, occupancy mapping, occupancy detection, occupancy velocity, indoor air quality (such as volatile organic compound and CO2 concentration), light intensity, and more. These sensors can be classified into low power and high power categories, based on the amount of power required for data collection and reading. Device data 430 includes the information sensed by the device's sensors, which is then stored. It should be noted that not all sensed data is stored, as some may be immediately transmitted to another device. The device data encompasses additional details, such as timestamps that record specific events, energy readings like battery and solar panel energy levels, unexpected energy accumulation amounts, and so on. This data can also be stored for specific time periods, and it is typically, though not always, stored in the device's memory 460. The model of energy consumption is such that regular/periodic actions are taken by the device. With such a model, the energy generated may be expected to generally handle the regular/periodic actions with some leeway.

The device 400 may also incorporate a clock 440, which possesses a known ppm error (clock drift) 445. The clock drift 445 may be stored such that the device itself can access it. Clock drift refers to the disparity in the ticking rate between two distinct clocks over time, typically measured in parts per million (ppm). It indicates the relative deviation of a clock from an ideal reference clock during a specific time interval. The measurement in ppm signifies the number of clock cycles gained or lost per million clock cycles. In the context of clock drift, a clock that drifts at a rate of 1 ppm would experience a gain or loss of one clock cycle for every million clock cycles it counts. This measurement provides a precise assessment of clock accuracy and enables comparisons between clocks operating at different frequencies. For example, considering a clock with a frequency of 10 MHz and a drift rate of 1 ppm, in one second, this clock would tick 10 million times. If the clock drifts by 1 ppm, it would deviate by ten ticks. It is important to note that both the sending device and the receiving device are subject to clock drift. The level of uncertainty is at influenced, at least in part, by the amount of clock drift present in both the sending a receiving devices.

The device may be designed with a processor 415 which can make certain decisions, such as where to send data, may make calculations, such as determining energy data, and so on. This processor may allow the device to compute methods and algorithms described herein. The processor may be a microprocessor. The microprocessor may comprise high-efficiency signal processing, low power, low cost, or may have other features. The processor may include energy management circuitry. This circuitry may perform functions that regulate the flow of energy between the solar panel, the battery, and other device components. This circuitry may be used to ensure that the battery is charged efficiently and that the device operates within its power constraints. In some embodiments, energy management may be performed in software or firmware. Depending on factors like ambient lighting intensity, duration of ambient exposure, and the device's energy consumption, the battery's level of charge can vary. This leads to varying levels of battery availability for the device's operation. To help with power management, and to assist running the device, a memory 460, which may be incorporated into the processor 415 may store the current battery level 464, recent power income, data specific to the device 430. The device data 430, in an illustrative embodiment, is data that the device senses and then stores. Not all sensed data may be stored., some may be sent immediately to a different device. Other device data may be data that is sent from a controller, other sensors, etc. The memory 460 may be flash memory, or a different sort of suitable memory.

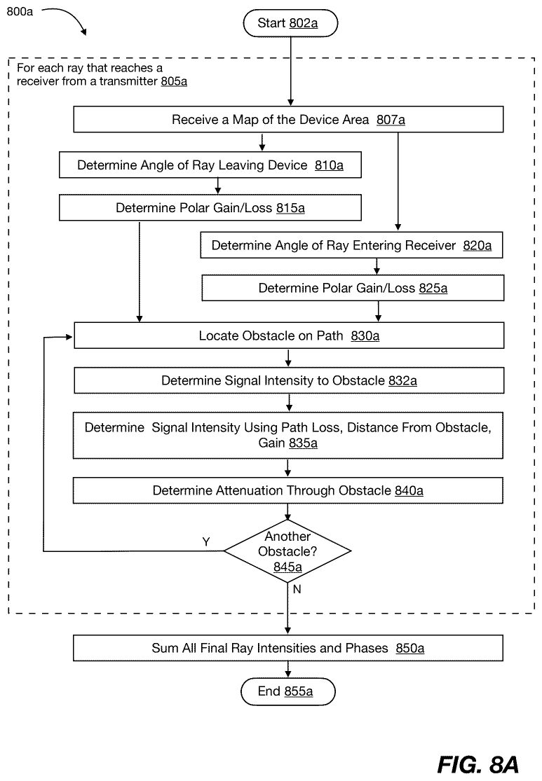

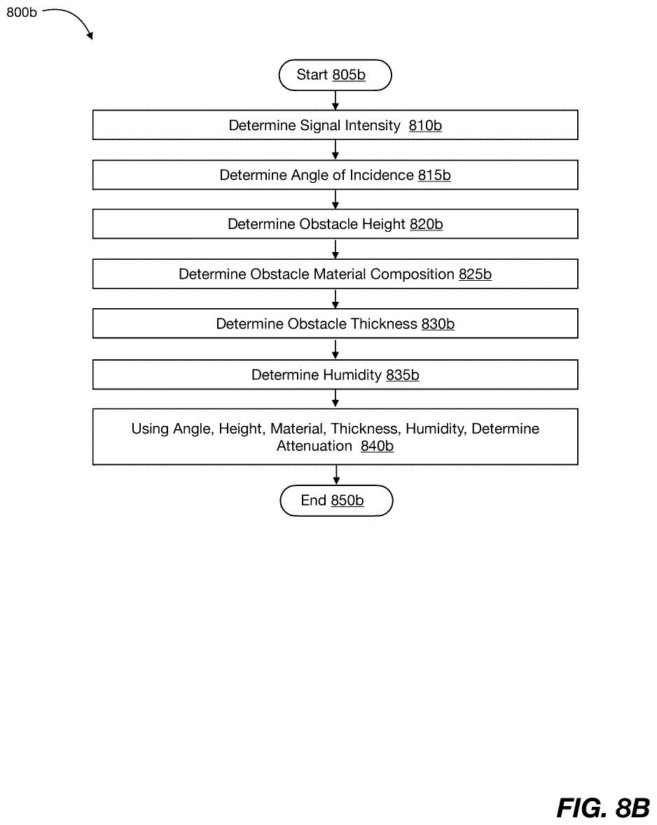

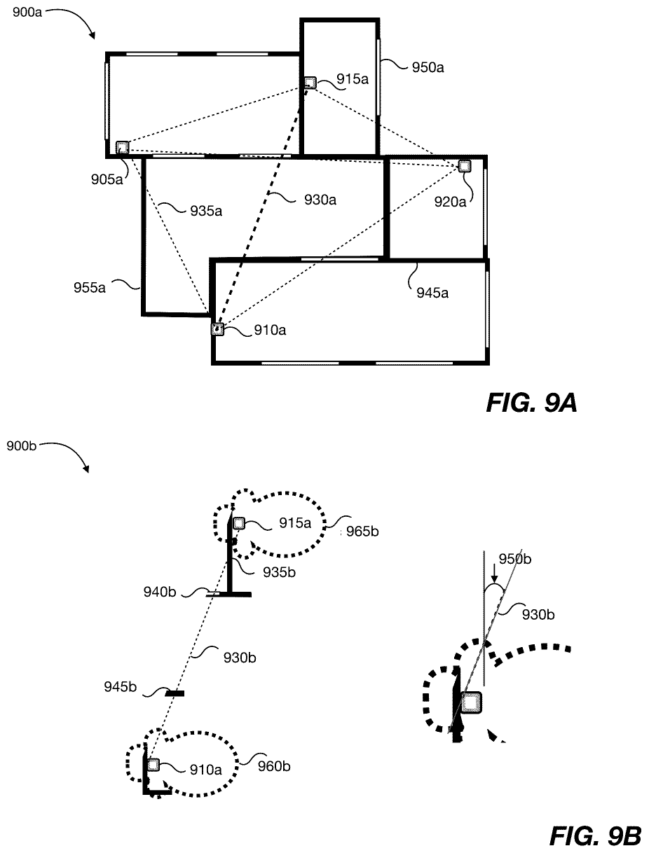

A communications interface 435 may also be included which includes many different portions, some of which are shown here. In the communications interface 435 may be a radio 450. The radio may allow the device to send device data to another entity, such as a controller that controls the device 400, another device, or a different entity. An antenna 452 is a fundamental component of a radio system. It is a specialized device designed to transmit and receive electromagnetic waves, including radio waves. In the context of a sensor, an antenna is used to efficiently radiate RF signals into the air for transmission and capture incoming RF signals for reception. When a device needs to send data to another device, the radio modulates the data onto an RF carrier signal. Modulation involves altering the properties of the carrier signal (such as amplitude, frequency, or phase) according to the data being transmitted. This modulated signal is then fed to an antenna 452. The antenna 452 takes the modulated RF signal and radiates it into the surrounding space, where it may be received by another device 400, a controller 200, etc. The properties of the antenna, such as its shape and size, determine the radiation pattern and directionality of the emitted signal. These properties, and properties of the received signal are also discussed with reference to FIG. 8, FIG. 9A, and FIG. 9B. When the device needs to receive data, the antenna captures incoming RF signals from the environment. These signals could be transmitted by other devices 400, a central controller 200, or any other transmitting device. Attenuation may affect the original signal depending on the configuration of the space between the sending device and the receiving device.

The captured RF signal is then passed to the radio. The radio's receiver demodulates the signal, extracting the original data from the modulated carrier signal. Demodulation reverses the process of modulation, recovering the encoded information. This radio may send radio waves, packets of information, etc. to other radios, such as other devices, controllers, other devices, other computer systems that incorporate radios, etc. The packets may be encrypted before they are sent. This encryption may be done by the radio 450, the processor 415, etc. The radio signals may be in the form of packets. These packets may be encrypted, in which case, the radio 450, the radio 450+the processor 415, the processor 415, etc., may decrypt the packets so that they may be used. The radio may also be able to determine the strength of a signal that it receives. The antenna 452 may have one or more polar gains chart associated with it. These polar gains charts may indicate the signal strength expected depending upon the angle (horizontal, vertical, a combination of the two, etc.) which the signal is sent. The signal strength may be represented by a received signal strength indicator (RSSI), or may be represented by another method.

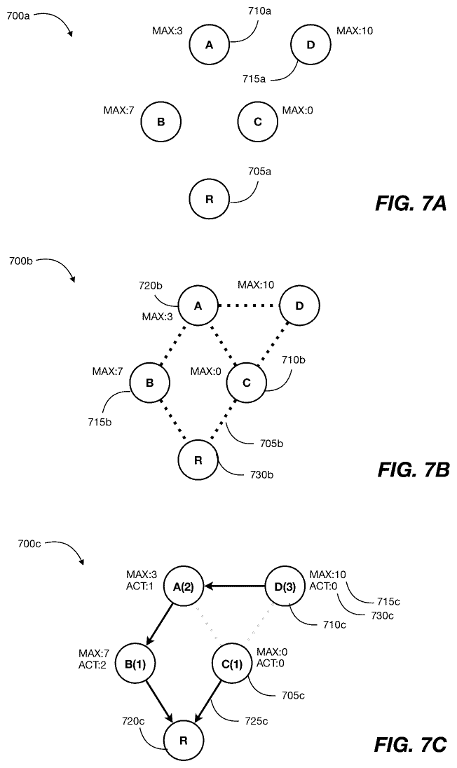

A memory 460, which may be incorporated into the processor 415, stored in central database for a central program to use to organize the network, etc, may store information such as the current battery level 464, recent power income 466, data specific to the device 430, and instructions used to create a network that efficiently utilizes this type of device with variable power income 400. The device data 430, in an illustrative embodiment, is data that the device senses and then stores. Not all sensed data may be stored., some may be sent immediately to a different device. Other device data may be data that is sent from a controller, other sensors, etc. The memory 460 may be flash memory, or a different sort of suitable memory. There may be a processor 415 on board which can make certain decisions, such as where to send data, may make calculations, such as determining energy data, and so on. This processor may allow the device to compute methods and algorithms described herein. The device may be able to communicate directly with a mobile device, such as upon commissioning, during maintenance, as an alternative method of communicating with a computer 200, etc. This device may be used in a low-power wireless network, such as shown with reference to FIG. 7C. Devices in a low-power network receive various types of messages based on the application's requirements. For example, devices may receive sensor data from other devices to gather environmental information, such as temperature, humidity, light levels, etc. Devices can receive control messages to adjust their behavior or request specific actions, like changing the sampling rate or reporting status. In network routing, devices may receive routing messages to establish communication paths, update network topology, etc. These messages that the devices receive and send may be sent using the amount of power that a node has, the power number, or a different measure of power requirement to determine timing, in that a device with more power may receive messages, or be required to send messages more frequently; while a lower power device may receive and send messages less frequently. Devices may receive control messages to adjust their behavior or request specific actions based on power amount, like changing the sampling rate or reporting status. Devices may themselves change behavior based on the amount of power the device has, is projected to have, etc. In some embodiments, the controller sends a control message to a root device. The root device then sends the control message to the children of the root device at the time to send control messages. The children devices then send the control message received at the next send control messages time to their children, and so on, until all devices have received the control message.

The device 400 may have a power cord or other method that provides essentially unlimited power to the device. This may be a specialty device, such as a root device in a network otherwise composed of variable power devices without power cords. A user interface 455 may allow a user to communicate with the device 400.

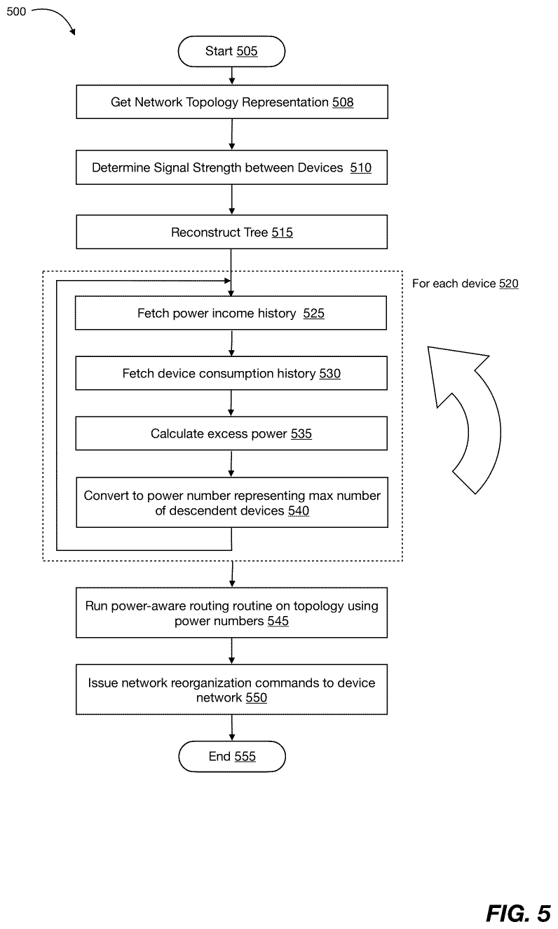

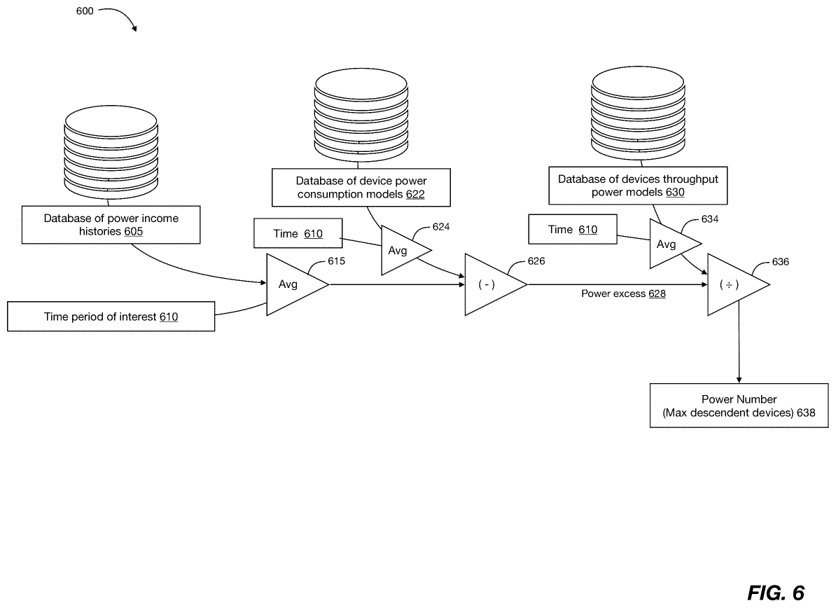

FIG. 5 illustrates an example of a method 500 for creating a low-power network that effectively utilizes devices with a variable amount of energy. The method 500 may correspond, for example, to the network creation instructions 468 of FIG. 4. The method may be performed in a device 400, a sensor system 140, a controller 200, within a distributed controller system 130, etc. The device may also be performed on a processor 1520 and memory 1530, utilizing the storage 1560. The method 500 may be, in some respects, an abstraction and a general description of the operations performed by a device, a controller, or a computer for creating a variable power network; various additional details regarding example implementations of some steps of the method 500 will be described in greater detail below with respect to FIGS. 6, 7A-7C, 10, and 13A-14.

The method 500 begins in step 505 and proceeds to step 508 where a network topology representation is fetched 510. Then, for each pair of devices, or some subset thereof, the signal strength between them is calculated. This includes determining the attenuation between objects within the signal path. Calculating attenuation is described in greater detail in FIGS. 8A and 8B, and may be performed by a controller 200, a device 400, or a different piece of equipment. After the signal strength is calculated, the closeness in network terms is known between the devices. Then, the network tree is reconstructed 515 taking these signal strengths into account, such that the network attempts to create the network tree such that dependent and neighbor devices are as close (in signal time) as possible.

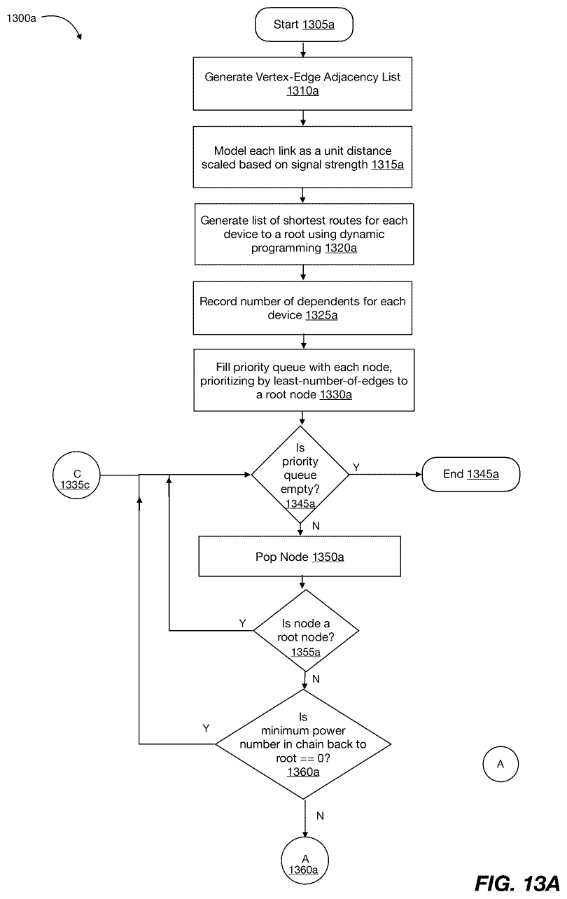

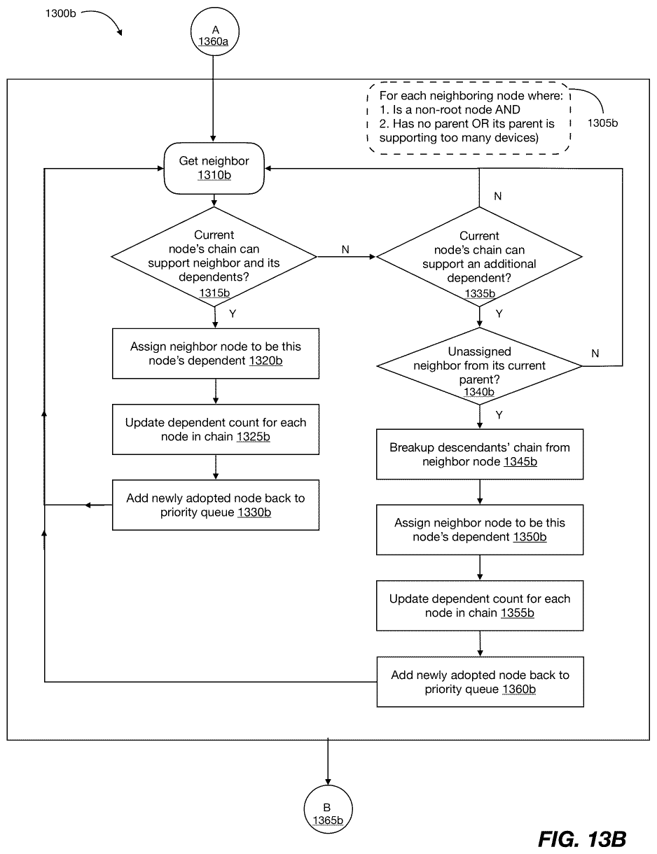

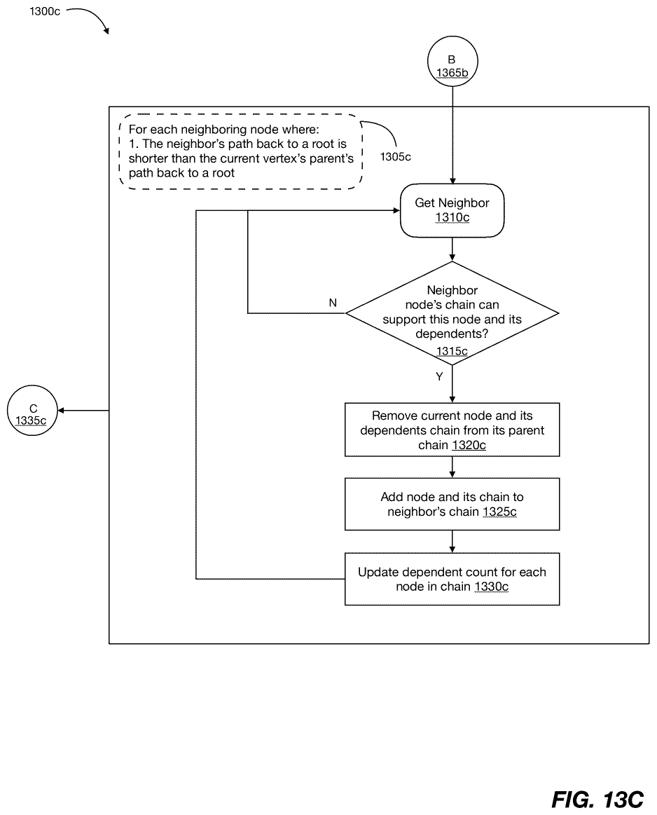

Next, the power number for each device is calculated. This number gives the number of dependent devices each device can handle. As some of the devices may be variable power devices with solar panels providing at least some of the power, the amount of power they have may be dependent on where within a structure the devices are. How long lights are on near them, the type of lights near them, the amount of ambient light in their area may all be variable. Devices that have electric power may have an infinite power number, as they do not rely on variable power For each device that has variable power, the power income history 525, the device consumption history 530, and the power throughput of similar devices 535 are fetched from the appropriate location (such as the database 1571, 1572, and 1573 respectively). At step 540, these values are used to calculate the power number. This represents the maximum number of descendent devices a specific device can have. A more detailed explanation of the power number calculation is found with reference to FIG. 6. Once the power numbers are calculated, then at step 545 a power-aware routing routine is run on the network topology using the power numbers. explained with more detail with reference to FIGS. 13A and 13B. A simple example is described with reference to FIG. 7A. At step 550, network reorganization commands are issued to the device network. At step 555, the method ends.

FIG. 7A shows a series of devices 700a that have been placed within a structure, with the structure removed for clarity. The root node (or gateway) of the network, R, is shown at, e.g., 1405a. It is generally assumed to have a power number that is as large as necessary, so in some implements its power number is not calculated as it is, e.g., it is not a battery operated device; the amount of energy it will possess may be dependent on location, time of year, etc. In this example, device A 710a has a power number of 3 (MAX:3, indicating that the max number of descendants this node can have is 3), Device D 715a has a power number of 10, and so on. Using the power number, the number of descendant devices that a device can have in a network is determined. This determination, in some embodiments, is the same as the power number, e.g., the power number is the number of descendants that each device may support. In some embodiments the power number represents the number of descendant devices in a different manner.

In a hierarchical structure, a descendant node refers to a node that is located lower down in the hierarchy, farther away from the root node, and is connected by a series of parent-child relationships. Descendant nodes are nodes that come after a given node as you trace the path downwards from the root node towards the leaves of the tree. Power numbers are a abstract/normalized quantity of excess energy. Neighbor nodes are nodes that can be reached with a single hop. FIG. 7A shows a series of devices that have yet to be connected. The root, 705a, represents a device that is powered by electricity (e.g., it is plugged in.) The other nodes, have a max number, which indicates the number of dependent devices each device represented by the nodes e. For example, node D 715a represents a device that can have 10 dependent devices, while node A 710a represents a device that can have a max of three dependent devices. A sample connection graph created by determining how devices can communicate in situ is shown with relationship to FIG. 7B. Descendants—all of the dependents of a device” just devices further from the root which depend on the device in question to forward their communications. These descendants each represent additional bidirectional networking throughput. They represent a proportional increase of power consumption for each node supporting them in the chain back to the root, uniformly. Thinking another way, descendents are devices further from the root which depend on the device in question to forward their communications. The root is R 705b. The child node C 710b to the root node 705b has two descendent nodes —the children D and A 720b. Any children of D and A 720b, all the way down the network to the leaves (the terminal nodes) will also be descendants of C 710b. At step 520, the locations of the devices (when known) is taken into account to determine which devices can be neighbors to other devices. This is described with greater detail with reference to FIGS. 8A and 8B. The signal strength step 510, in some embodiments, develops the graph that shows how devices can be connected, among other things. Here, the dotted lines represent allowed connections between devices. For example, the root R can connect, along 705b, to C 710b. C 710b cannot connect to B 715b.

The signal strength calculation 510 determines which devices can connect directly, which is taken into account by the network reorganization. A network tree is a hierarchical structure that is designed to accommodate the potential maximum number of descendant nodes for each individual device, all while ensuring the shortest possible route from any node to a designated relay node. This network architecture is crafted to strike a balance between optimal data transmission paths and the requirements of the different devices that make up the network, each of which may have its own variable power supply. As discussed with reference to FIG. 4, these devices 400 may have a solar panel that is used to recharge a battery. The amount of ambient light than an individual device may receive is a function of where the device is placed within a space, the time of year (for light from outside), whether modifications have been made to the structure that block or allow light to the device, etc. The maximum number of descendant nodes that a device can have is taken into account during the construction of the network tree by using the power number. This consideration ensures that the tree can effectively accommodate a varying number of devices connected to a relay node without compromising the integrity of the overall structure, as the devices should be sufficiently powered. At the same time, the architecture of the network tree is designed to preserve the shortest communication routes between any node and a designated relay node. By maintaining the shortest route to this relay node within the other restrictions, the network ensures efficient and rapid communication between nodes, minimizing latency and optimizing the overall performance of the network. Such a network 700c is shown with reference to FIG. 7C. Device C 705c has a power number of 0, indicating that it cannot have any descendants. Therefore, it is connected directly 725 c to R 720c, and is the child to R, as indicated by the (1), e.g., 1 generation away from the relay node. Node D 710c is connected as a descendent to A. Its max number of descendants, from its power number, is 10 715c; its actual number of descendants is 0 as represented by “ACT:0” 730c ; and its number of generations from the relay is 3, as represented by “D(3)”710c. Due to the power restrictions that different devices have—maximum descendants, devices that can only be connected to a subset of possible devices, etc.—an optimal network may not be able to be created. One method to create an optimal network with the restrictions given is shown with reference to FIGS. 13A and 13B. At step 550, the network is reorganized according to the topology determined in step 545. At step 550, the method ends.

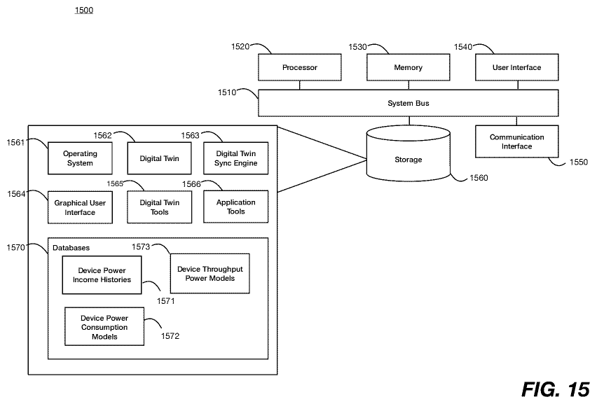

FIG. 6 illustrates an example method 600 for determining a power number for a device. The method 600 may correspond, for example, to the power number instructions 462 of FIG. 4. It may also be performed by the processor 1520 and memory 1530 of FIG. 15, and may utilize the databases 1570, including the power income history database 1571, the device power consumption models 1572, and the device throughput power models 1573. The method may be performed in a device 400, a sensor system 140, a controller 200, within a distributed controller system 130, etc. The method 600 may be, in some respects, an abstraction and a general description of the operations performed by a device, a controller, or a computer for creating a variable power network. These power numbers may be calculated when a network tree is reorganized. In some embodiments, recalculation of the power number and reorganization of the network tree is triggered when a change in historical power income, battery level, or excess power exceeds a predefined threshold. Such thresholds may be expressed as absolute energy differences, percentage changes, or predicted time-to-depletion values. Power numbers are an abstract/normalized quantity of excess energy. The power number may be represented as an integer, a real number, or another numerical quantity. In some embodiments, non-integer values may be rounded or thresholded when assigning discrete descendant devices.

In some embodiments, the excess power value is divided by an average per-device throughput energy cost to produce a normalized capacity metric, also referred to herein as the power number. The power number represents the maximum number of descendant devices that can be supported without causing the device to enter a negative energy condition. The power number may be calculated as an abstract representation of excess power income over a selected time period. This is quantified as the number of peer devices throughput supportable at a specified rate, before going power negative. The power number does not have to be an integer value; integers are used in the examples herein for simplicity's sake. In some embodiments, when a power number is checked for a device, the power numbers for every device in the network is also checked. In some embodiments, devices that have indicated some sort of distress or error level are checked.

A database of power income histories 605 e.g., how much power was received, for the specific device is averaged 615 over a time period of interest 610. The model of power income is based on the assumption of continued power income patterns over a specified period. The specified time period of interest window 610 can be a cycle of one day, one week, a month, a year, or another window 610 period. Power income histories are based on a power consumption mode for base device power operation parameterized by the transmit (TX) power setting divided by the gain setting of the device, along with reporting and sensing rates. The cost of modeled throughput of peer-device messages may also be used in the calculation. Any given device may be placed in a location that has more or less sunlight, generating a novel power income number for each device. The period of time used 610 may be a recent period of time, or any desired time period for any desired length. For the same time period of interest 610 power consumption models 622, i.e., how much power was used by the device, are averaged 624 over the same time period length 610. The average consumption is then subtracted 626 from the average income, giving the power excess 628. The amount of power that all the devices in the network use 630 for the time period of interest 610 (the device throughput power) is then averaged 634 over the time period of interest 610 to produce an average device usage. The excess power 628 is then divided by the device throughput average 636 to determine the abstract power number 638; that is, the maximum number of dependent devices that a given device can have. The device throughput power model may include energy consumed during both transmission (TX) and reception (RX) of forwarded messages. Because descendant devices require bidirectional communication support, the throughput cost for each additional descendant may include expected transmission energy, reception energy, acknowledgment handling, and protocol overhead.

In some embodiments, the power number is obtained by normalizing the excess energy value using a projected bidirectional communication cost per descendant device. The projected bidirectional communication cost may include energy consumed for forwarding data transmissions, receiving forwarded data, transmitting acknowledgments, receiving acknowledgments, and performing retransmissions in response to packet loss or interference. Because descendant devices require upstream and downstream communication support, the normalization may account for both transmission and reception overhead as well as protocol-layer retransmission behavior.

As used herein, a negative power condition refers to a sustained net energy deficit over a selected historical time period. In particular, a negative power condition occurs when predicted cumulative energy consumption over the selected time window exceeds predicted cumulative energy income, resulting in a projected decrease in stored battery energy.

A negative power condition does not necessarily refer to an instantaneous mismatch between power consumption and power harvesting at a given moment, as temporary imbalances may be accommodated by stored battery energy. Rather, the negative power condition describes a modeled condition in which the average or cumulative energy usage over the selected historical time period exceeds the average or cumulative harvested energy, such that continued operation at the modeled rate would lead to battery depletion or inability to sustain required communications.

In some embodiments, avoidance of a negative power condition serves as a constraint during network tree formation, such that a device is not assigned more descendant devices than can be supported without entering the negative power condition over the selected modeling interval.

In embodiments where at least one of the devices harvests energy from ambient light, such as via a solar panel, the time period of interest may be selected to correspond to a complete daily light cycle. A complete daily light cycle may include both expected illuminated intervals and expected non-illuminated intervals within a 24-hour period, or another period reflecting the natural or artificial lighting schedule of the installation environment.

Energy harvesting devices often experience cyclical variations in power income due to day-night transitions, scheduled lighting operation, seasonal daylight variation, shading from structural elements, and occupant behavior. Modeling power income over only a partial interval (e.g., only during daylight hours) may overestimate available energy, while modeling only dark intervals may underestimate sustainable capacity. By selecting a historical time period that spans at least one full light-dark cycle, the calculated average power income reflects both charging and discharge behavior, thereby more accurately representing net energy accumulation.

In some embodiments, the daily light cycle may be defined based on measured illumination patterns at the device location, a configured lighting schedule, astronomical sunrise and sunset data, or observed solar panel output patterns stored in the power income history database. In other embodiments, multiple daily cycles may be averaged to smooth transient anomalies such as temporary shading or atypical lighting conditions.

The use of a complete daily light cycle for historical averaging improves the stability of the calculated excess power value and, consequently, the derived power number representing descendant support capacity. This approach reduces the likelihood of overestimating routing capacity during temporary high-illumination conditions or underestimating capacity during temporary low-illumination conditions. In some embodiments, the historical time period may span multiple complete environmental energy cycles, such as multiple daily light-dark cycles. Averaging across multiple cycles may reduce the influence of transient anomalies including temporary shading, short-term lighting changes, or unusual occupancy patterns. Such multi-cycle averaging may smooth transient energy spikes or dips and provide a more stable estimate of sustainable excess energy for descendant support calculations.

In some embodiments, the time period of interest comprises a rolling window that advances at predetermined intervals. For example, the window may represent the most recent 24 hours, 7 days, or other selected duration, and may be recalculated at fixed intervals such as hourly, daily, or upon receipt of updated power measurements. In this manner, historical power income and consumption values continuously reflect recent device behavior.

In some embodiments, the power number is checked periodically to be sure that the amount of power that the devices in the network have has not changed so drastically that the network integrity is comprised. In some embodiments, the routes for data between devices can be multi-path to share the load.

Devices with wireless communication capabilities and low power consumption (e.g., 400) often have a restricted radio coverage area. This coverage range could be even more constrained due to obstacles obstructing the signal path between the sensors and the device they need to communicate with. To prevent the establishment of a non-functional network in real-world scenarios, it's possible to generate an attenuation map that more accurately determines the coverage range. This map provides accurate information about the actual distances that the device can effectively communicate within a given structure.

FIG. 8A illustrates a method 800A for determining the signal strength of a first device when reaching a second device. As such, the method 800 may correspond to the step 510, determining attenuation to other devices, in FIG. 5. In some embodiments, the computer-enabled method 800 may be implemented in one or more controllers 220. Within the controller 200, a digital twin 220 and an associated database 226 may be used to determine distances between devices, aspects of the structure that the first and second device are in, etc. These devices may be the device shown in FIG. 4, the device shown in FIG. 17, or a combination of the two.

At operation 802a, the method begins. For any given transmitter receiver pair, the receiver may receive multiple transmissions from the same receiver. The dotted box 805a which encompasses steps 807a through 845a indicates the actions that should be taken for each ray received by a transmitter from the same receiver. At operation 810a, a map of the device network area is received. The map may be received from a digital twin 220 environment twin, as described with reference to FIG. 2 and the associated text. When devices are installed that will be used for a network, these devices may be accurately included within a map of the controllable system 120 that makes up at least a portion of map associate with an environment twin 222. A sample (greatly simplified) map with network device locations 905a, 910a, 915a, 920a is shown with reference to FIG. 9A at 900a. This map has been simplified for readability. Here, we can see that the dimensions of the space are represented, where external walls 955a, internal walls 945a and windows 950a are located.

At step 810a, the angle of a ray leaving the first device is determined. In some embodiments, the signal will be traveling between two devices at different heights. For example, devices may be on different floors, in which case, the path will go through a ceiling and a floor, which needs to be addressed. In such cases, two angles may be determined, the vertical and the horizontal angle. At step 820a the angle (or angles) of a ray entering the receiver (a second device) is determined. One method of doing this is by drawing a path from the first device to the receiver device using the map retrieved in 802a. As an example, a sample path 930a is drawn on a map from a device e.g., 910a to another device 915a, at an angle to a surface that intersects the transmitter on the transmitting device 910a and the receiver on the receiving device 915a. These locations can be determined using the database 226 of the digital twin 220 which may hold information about the location of the devices and the specific configuration of the devices, thus allowing the transmitter and receiver to be located. At 815a and 825a the polar gain/loss of the signal from the device is determined. FIG. 9B at 900b illustrates an example of a determining gain/loss for a signal. This figure may correspond, for example, to steps 810a and 815a, and 820a and 825a of method 800a. A sample path 930b is drawn on a map from a device e.g., 910a, to another device, not shown. With reference to FIG. 16, an example of how to determine the polar gain/loss is described.

At step 830a, the path is followed from the original device until an obstacle is encountered. This obstacle may be a structure that has a different signal attenuation than air. For example, this may be a marked representation, such as an inner wall, a ceiling, a window, a pillar, an outer wall, a load-bearing wall, etc. The distance that the ray goes until encountering the obstacle may also be included in the attenuation calculation, as air has an attenuation.

At step 832a, the signal intensity prior to the obstacle is determined. To do so, the distance from the transmitting device to the obstacle is used, along with the polar gains, in a pathless function that determines signal intensity.

At step 835a, the signal intensity at the end of the obstacle, including attenuation through the object, is determined. This is described with greater specificity with reference to FIG. 8B. At step 845a it is determined if there is another obstacle. If so, then the method moves to step 830a. If there are no more obstacles, then at step 850a, the final signal intensities are summed and phase interferences are calculated to determine the final RSSI. If there is only one signal, then this step can be skipped. Signals are waveforms, with a phase, which is the position of the waveform relative to a time reference. When two or more signals overlap, the individual phases can cause the signals to either reinforce or cancel each other out. This step calculates the combined intensity of the signals including the constructive and destructive interference. The final signal strength is the expected signal strength of a signal transmitted from a first device to a second device at the expected location in a structure. At step 855a, the method ends. This method may be repeated between every set of devices that will make up a network.

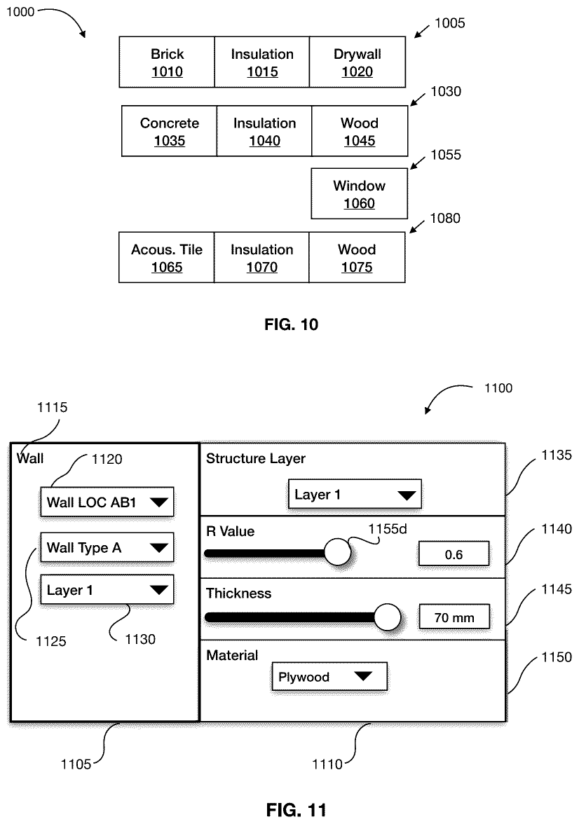

FIG. 8B illustrates a method 800B for determining signal intensity through an obstacle. As such, the method 800B may correspond to the step 840a in FIG. 8A. In some embodiments, the computer-enabled method 800 may be implemented in one or more controllers 220. Within the controller 200, a digital twin 220 and an associated database 226 may be used to determine aspects of the object, such as the object material, thickness, height, etc. An example of a portion of such a database structure is shown with reference to FIGS. 10 and 11.

At step 805b the method begins. At step 815b the angle of incidence that the signal hits the obstacle is determined, e.g., using the digital twin database 226. The obstacle height 820b is pulled from the database and used to determine if the obstacle is within the path of the signal. For example, a low column may be below the signal and so the signal may not hit the column at all. In some cases humidity 835b may also be used to calculate attenuation. This may be gathered from a database or may be taken from a physical sensor. If gathered from a database, the humidity 835b may be an average value, etc.

A variety of other qualities that may be used to determine attenuation are gathered. For example, the obstacle material composition 825b may be determined. The material composition, thickness, resistance value, and other physical characteristics of obstacles may be retrieved from a stored structural map, such as a digital twin database 226 of the environment. These retrieved properties are used to calculate attenuation of a signal passing through the obstacle. As an exemplary example, the model of the controllable space being used may include the main thermodynamic masses (or thermal masses) in the controlled space, e.g., walls, windows, floors, ceilings, etc. An additional mass that represents properties within the zone, such as air, may also be included. These major masses may have separate material attenuation coefficients. Major masses may themselves be composed of different masses that themselves have separate material attenuation coefficients. The obstacle thickness 830b may also be determined.

The angle of incidence that the signal hits the obstacle 815b, is a also determined. This angle, combined with the material composition of the obstacle, can be used to determine scattering or reflection, which may be used to account for additional loss of the signal. he angle of incidence of the signal may also be used to determine which percent of the angle will be reflected, and which percent will be transmitted through the obstacle. Snell's law may be used to determine the angle of refraction. Based material properties of the obstacle and obstacle thickness the percentage of the signal that will go through the wall may be estimated or determined. Some obstacles will block wifi signals entirely, such as by their material properties (e.g., concrete, metal doors and walls, etc.), thickness, etc. When an obstacle that totally blocks signals is encountered, the attenuation map may reflect the lack of signal from that location through to the end of the path. In some embodiments, the attenuation through materials as an attenuation coefficient is listed in a database, and is then accessed along with the thickness of the object or layer in the object. In some exemplary embodiments, little is known about some or all of the objects'attenuation characteristics. In such cases, a reasonable guess may be made depending on the location of the object within the map. For example, all wall objects (or objects that may be guessed to be walls) may be given the wall attenuation value, with window objects given a window attenuation value and so forth. The discovered attenuation may then be added to an attenuation map.

At step 840b, the attenuation of the signal strength through the obstacle, and thus the signal strength after leaving the obstacle using the gathered factors (815b-835b) and original signal intensity 810b is determined. At step 850b, the method ends.

FIG. 10 illustrates examples of structure composition-- different layers 1000 of which objects may be composed, and which are encoded within a database, such as the database 226. These layers may affect wifi signal attenuation. It will be understood that FIG. 10 constitutes, in some respects, an abstraction, and that the actual organization of the layers within an object within the database may be more or less complex than illustrated. Objects discussed here include an exemplary outside wall, an exemplary basement floor, an exemplary window, and an exemplary ceiling. More specifically, certain outside walls 1005, for example, may comprise a brick layer 1010, an insulation layer 1015, and drywall 1020. A floor example 1030 may have a concrete layer 1035, an insulation layer 1040, and a wood layer 1045. In this embodiment, rather than being included in a wall layer, windows 1055 are represented as a separate window layer 1060 with its own attenuation qualities. Windows may also have a different refraction index than the wall that the window is in, which may be taken into account. A ceiling layer 1080, as shown here, has an acoustic tile layer 1065, an insulation layer 1070, and a wood layer 1075. Similarly named layers may have different properties, represented by different parameter values, such as different r (resistance) values. For example, the insulation layers 1015, 1040, and 1070 may all have different properties that lead to different attenuation behavior. These different layers and their properties of the system such as shown in FIG. 10 may all be captured in the map possibly created by and used by the digital twin 220.

FIG. 11 illustrates an example of an interface 1100 for entering obstacle composition to be used to create, update, etc., within a digital twin database 226 of a controllable system 120, such as might be used with embodiments described herein. The interface 1100 may be displayed on a visual display of any device such as, for example, a personal computer, laptop, tablet, smart device, personal phone, etc. The interface 1100 may be presented as part of a larger software suite, to, for example, create an optimal device network for controllable system 120. It will be appreciated that the various principles described herein may be adapted to other contexts, such as software for building automation systems more generally, or any software that may enable a user to input building information.

As shown, the interface includes two panels: a location panel 1105 and a layer panel 1110. Generally, the location panel 1105 enables a user to choose a specific layer within a larger thermodynamic mass (e.g., a wall, window, floor, ceiling, etc.), while the layer panel 1110 enables the user to input specific thermodynamic information about a layer, this may include, for example, an attenuation coefficient (not shown), or the attenuation coefficient may be connected from a different location, such as a different database. The location panel 1105 includes multiple attributes that correspond to various nested locations within the controllable system 120. This interface embodiment is for a “Wall,” 1115; various other interface embodiments may exist for other thermodynamic masses within the system. The attribute displays correspond to respective attributes of the underlying data set. For example, as shown, items within the underlying data set may have attributes (e.g., columns within a data table, etc) including wall location 1120, wall type 1125, and wall layer 1130. In some embodiments, more attributes may be included in the location panel; in some embodiments, fewer attributes may be included in the location panel. It should be appreciated that alternate graphical forms may be used for the attribute displays, and that different thermal mass types may have different attribute displays.

The layer panel 1110 includes multiple attribute display elements 1135, 1140, 1145, 1150 that describe a layer within a thermodynamic mass. This panel may include both drop-down menus 1135, 1150 that correspond to underlying data structures, and slider bars that allow a user to set a value by moving the slider indicator 1155, with the chosen value appearing in a text box. In this embodiment the thermodynamic characteristics r (resistance) value 1140, thickness, and material are available for user modification. Selecting another option for the drop-down menu 1135 allows another layer's thermodynamic values to be input.

In some embodiments, objects such as walls, ceilings, floors, etc., may have only a single layer, with the r value 1155 and thickness 1145 determining the thermodynamic nature of the object. The thermodynamic properties associated with objects input here, such as an attenuation coefficient, may be used to help determine attenuation for a signal.

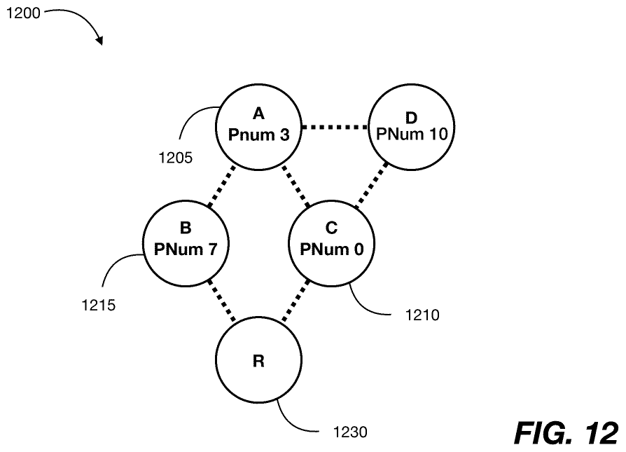

In FIG. 12, an illustration portrays a digital twin neural network representation of a sensor network 1200, serving as a model for a physical network comprising devices that are set to interconnect based on their power numbers and proximity to a root node. This specific neural network 1200 corresponds to the potential network configuration depicted in FIG. 7B at 700. Here, a primary node 1230 is presented, symbolizing the routing network device 730b. This routing network device 730b holds the possibility of establishing connections with devices B and C, represented by the neural network nodes 1210 and 1215. These nodes can be connected between node 1205 and node 1210, as well as between node 1205 and node 1215. However, there exists no connection between nodes B 1210 and C 1215, mirroring the permissible connections inherent in the wireless network 700b, as there is also no connection between B 715b and C 710b. Each of these nodes possesses a value akin to an activation value, the power number, as has been discussed, that matches the power number of the device the node is representing. Therefore, node C, labeled as 1210, has a power number of 0 1217, mirroring the power number of 0 associated with network device C, 710 b, and so forth. This digital twin neural network may be the same sort of network as described with FIG. 3 and the associated text.

Incorporating the potential configurations of the wireless network into the neural network architecture has already encoded a substantial amount of the requisite information for addressing this challenge. Importantly, the heuristics used enforces a restriction where the count of descendant nodes for each node must remain within the bounds of its corresponding power number. However, in some embodiments, the power number can be surpassed with the aim to minimize overflow—that is, drastic over-use of power by a second device. Devices can share the burden of an un-satisfiable network. The central device could also suggest addition of another device with dedicated power in the region. This heterogenous network does not need specific training, as all the information required to solve the problem is embedded in the neural network and the heuristic used to develop the physical network as embodied in the neural network. (150) FIGS. 13A, 13B, and 13C illustrate example method 1300a, 1300b, 1300c for creating a network tree. As such, the method 1300a, 1300b, 1300c may correspond to the step 545 of method 500. At step 1305a, the method begins. At step 1310a, the original mesh with a root, connections to devices, and power number are used to create a Vertex-Edge Adjacency List. This is done by iterating through each vertex and create an adjacency list that represents the connections between allowed vertices. This adjacency list also contains the signal strength between the devices at each list location. The root vertex is also marked. At step 1310a, the vertices with excess connections are marked. At step 1315a, each connection link is modeled as a unit distance in the vertex-adjacency list is given a unit distance scaled based on the signal strength between the two devices. At step 1320a, a list of shortest routes for each device to a root is generated. This list may be generated using dynamic programming or another method. For example, the shortest path from the vertex (which represents a device) to the root vertex may be found with Djikstra's algorithm, a variant of which fixes a single node as the root node and finds shortest paths from the source to all other nodes in the graph, producing a shortest-path diagram. Other shortest-path algorithms may also be used, such as Jump point Search, A* algorithm, Theta* Algorithm, or Cooperative A* algorithm. Dynamic programming techniques which can be adapted to work on multi-root networks may also be used.

At step 1325a, the number of dependents for each device in its shortest route to a root node is recorded. At step 1330a, a priority queue is filled with each node that represents a device, prioritizing by least-number-of-edges to a root node, At decision point 1345a, it is determined if the priority queue is empty. If so, at 1345a the method ends. If not, at 1350a a node is popped. At decision point 1355a it is determined if the node is a root node. If so, the method continues at step 1345a. If not, the method continues at decision point 1360a, where it is checked to see if the minimum power number in the chain back to the root=0. If so, then the method continues at step 1345a. If not, then the method continues at FIG. 13B 1365b. In some embodiments, adoption or reassignment of a descendant device is permitted only if every device in the chain from the descendant device to the root node remains within its respective maximum allowed number of descendant devices. Thus, the capacity constraint is enforced across the entire upstream chain rather than solely at the immediate parent device.

With reference to FIG. 13B, this applies to the node that was popped at step 1350a. The purpose of this routine is to find and adopt orphaned neighbors, or neighbors with parents who cannot support them, where possible. For this node, the method 1300b is used for each neighboring node where it 1) is a non-root node and 2) either has no parent or its parent is supporting more devices than its power number allows 1305b. For the nodes that are root nodes or that have the same or fewer nodes than its power number, this method is bypassed, and continues onto B 1365b, which leads to FIG. 13C at 1365b.

Assuming the conditions above are met, then at step 1305b a neighbor (which is a non-root node or (has no parent or its parent is supporting too many devices as indicated by its power number) is fetched. At decision point 1310b, the current node's chain (node popped at 1350a) from the node to the root is checked to see if it can support this neighbor (fetched at 1305b) and the neighbor's dependents. If yes, the node can support the neighbor and its dependents, then at step 1320b the neighbor node (from 1310b) is assigned to be the current node's dependent. At step 1325b, the dependent count is updated for each node in the chain. At step 1330b, the previous neighbor node with its new dependents is added back to the priority queue. The method then continues at 1310b. If, at decision point 1315b the current node's chain cannot support the neighbor and its dependents, then the method continues at decision point 1335b. At 1335b, the current node's chain is checked to see if it can support an additional dependent. If not, then the method continues at step 1310b. If so, then the current node's parent is checked for an unassigned node. At decision point 1340b it is determined if this neighbor is unassigned to a parent. If the neighbor has a parent, then the method continues at step 1310b. If the neighbor is unassigned, then the method continues at step 1345b, where the neighbor's descendent chain is broken from the neighbor node. These descendent chain nodes should be in the priority queue, so they will be handled in turn. At step 1355b, the neighbor node is assigned to be this node's dependent. At step 1355b, the previous neighbor node, now newly adopted, is added to the priority queue 1360b. The method now continues at step 1310b.

Once there are no more neighbors that fulfill the requirements of 1350b to be fetched, the method continues at B 1365b, which leads to FIG. 13C at B 1365b. Some of the neighbors that fit the requirements of 1305b may also fit the requirements of 1305c; that is, some neighbor nodes may go through the method described in both 13B and 13C. The method shown in FIG. 13C is performed for each neighboring node of the current node where the neighbor's path back to a root is shorter than the current vertex's (node's) parent's path back to a root. That is, where the neighbor has a shorter path to the root than the node itself. The purpose is to give an opportunity for the current node to be adopted by a neighbor if it would result in a shorter path with a satisfied power number for the neighbor and all the neighbor's dependent nodes. At step 1310c a neighbor that fits the requirements of 1305c is fetched. Then, at decision point 1315c it is checked if this neighbor node's chain can support this node and the node's dependents. If not, then the method continues at step 1310c. If yes, then at step 1320c, the current node and its dependents are removed from its parent's chain. At step 1325c, the node and its chain is moved to the neighbor's chain. At 1330c, the dependent count for each node in the chain is updated. When there are no more neighbors that fit the definition of 1305c, then the method continues at FIG. 13A at C 1335c.

The reassessment of the connections at, e.g., 1330b and 1360b is performed to ensure that each vertex remains within the confines of its maximum allowed connections. Should certain vertices still surpass their permissible connection limits, an evaluation ensues to determine if further enhancements to the network are achievable. This step is crucial, as some networks might be unsolvable. In some embodiments, parent-child relationships are selected based at least in part on estimated signal strength between devices, such that stronger or lower-attenuation links are preferred when constructing the network tree, subject to descendant capacity constraints.

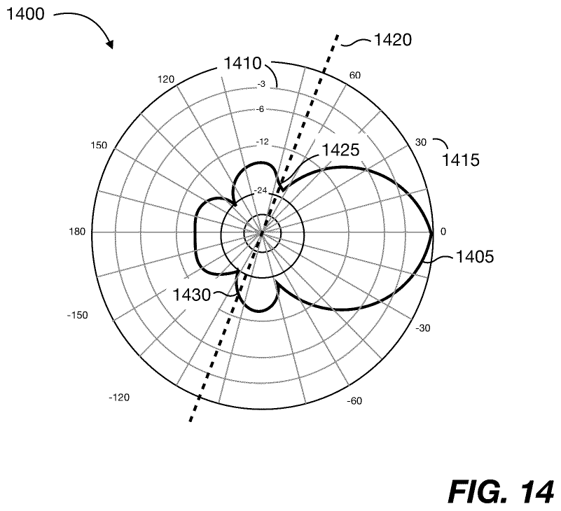

FIG. 14 illustrates an exemplary polar gain chart 1400 that may be used to determine signal attenuation, e.g., such as shown with reference to FIG. 9B. Polar gain charts disclose how much better or worse a signal or an antenna performs in different directions compared to a hypothetical perfect antenna that radiates equally in all directions. Radios often send out different signal strengths at different angles. These different signal strengths at different angles from the device are a product of radiation directivity, electrical efficiency, device design, etc. A polar gain chart 1400 describes these radio device signal strengths 1405 at various angles. Polar gain charts may be horizontal (azimuth), vertical (elevation), a combination, etc. This specific polar gains chart 1400 is a horizontal gain chart, which can be used to determine the signal strength expected from a given device at various angles on a horizontal plane. The chart 1400 is circular in shape, with the center representing the point where the antenna or transmitter is located. The angles are typically marked in degrees 1415 around the circumference of the circular plot. These angles represent different azimuthal directions, which correspond to different positions around the antenna or sensor. The radial lines 1410 extending outward from the center represent the radiation gain or sensitivity of the antenna or sensor at various azimuthal angles. The length of these lines indicates the strength or loss of the gain or sensitivity in a particular direction. The curve formed by connecting the ends of the radial lines 1405 (the polar gains curve) illustrates the antenna's or sensor's radiation pattern. This pattern depicts how the gain or sensitivity varies with respect to different azimuthal angles. The chart helps identify key features like lobes (regions of higher radiation) and nulls (regions of lower radiation). Lobes are areas where the radiation intensity is higher, while nulls correspond to areas with weaker radiation. By observing the chart, one can infer the antenna's or sensor's directivity, which indicates its ability to focus radiation in a specific direction while minimizing radiation in other directions. One can determine the strength of the signal entering or exiting device by observing the angle that the signal enters or exits. With further reference to FIG. 9B, the dotted line 1420, for example, represents the angle 950b that a signal exits the device 965b. The location that the line crosses the polar gains curve 1425 crosses the radial line at about −22, which give a loss of 22 RSSI in the signal strength. With reference to FIG. 9A, the signal enters the device 915a at about −18, shown by the point 1430, where the polar gain line crosses the signal line. This shows a loss of 18 RSSI for the signal entering the receiver, assuming the devices are at the same height, such that the vertical gain does not need to be taken into account.

A combination of horizontal and vertical polar gains charts may give the signal strength between devices at different heights and angles, such as devices on, e.g., different elevations, such as devices different floors. Specifically, two devices with a spacing S between them at angles A and B in the horizontal and vertical direction may have their expected signal strength (without obstacle intervention) determined using the equation: Signal Strength=ƒ(S, A, B, gain_chart). The signal strength may be in terms of RSSI. The polar gains chart is assumed to be oriented around a front of a device. For example, in FIG. 9b, the polar gain chart 960b is oriented to the front (the side opposite the wall) of the device 910a. The polar gains chart 965b for device 910a is oriented similarly, as both devices 910a, 915a, face the same way. If a polar gain chart is not available, a perfectly circular radial gain profile may be assumed.

FIG. 15 illustrates an example hardware device 1500 for implementing a mesh network creation system. In some instances some portions of the mesh network creation system may be divided between a device 400 and a device 1500, or many devices 400 or 1500, themselves networked. As shown, the device 1500 includes a processor 1520, memory 1530, user interface 1540, communication interface 1550, and storage 1560 interconnected via one or more system buses 1510. It will be understood that FIG. 15 constitutes, in some respects, an abstraction and that the actual organization of the components of the device 1500 may be more complex than illustrated.

The processor 1520 may be any hardware device capable of executing instructions stored in memory 1530 or storage 1560 or otherwise processing data. As such, the processor 1520 may include a microprocessor, field programmable gate array (FPGA), application-specific integrated circuit (ASIC), or other similar devices.

The memory 1530 may include various memories such as, for example L1, L2, or L3 cache or system memory. As such, the memory 1530 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 1540 may include one or more devices for enabling communication with a user such as an administrator. For example, the user interface 1540 may include a display, a mouse, a keyboard for receiving user commands, or a touchscreen. In some embodiments, the user interface 1540 may include a command line interface or graphical user interface that may be presented to a remote terminal via the communication interface 1550 (e.g., as a website served via a web server).

The communication interface 1550 may include one or more devices for enabling communication with other hardware devices. For example, the communication interface 1550 may include a network interface card (NIC) configured to communicate according to the Ethernet protocol. Additionally, the communication interface 1550 may implement a TCP/IP stack for communication according to the TCP/IP protocols. Bluetooth protocols may be used, as well. Various alternative or additional hardware or configurations for the communication interface 1550 will be apparent.

The storage 1560 may include one or more machine-readable storage media such as read-only memory (ROM), random-access memory (RAM), magnetic disk storage media, optical storage media, flash-memory devices, or similar storage media. In various embodiments, the storage 1560 may store instructions for execution by the processor 1520 or data upon with the processor 1520 may operate. For example, the storage 1560 may store a base operating system 1561 for controlling various basic operations of the hardware 1500.

The storage 1560 additionally includes a digital twin 1562, according to any of the embodiments described herein, such as a digital twin 226 in FIG. 2. As such, in various embodiments, the digital twin 1562 includes a heterogeneous and omnidirectional neural network. A digital twin sync engine 1563 may communicate with other devices via the communication interface 1550 to maintain the local digital twin 1562 in a synchronized state with digital twins maintained by such other devices. Graphical user interface instructions 1564 may include instructions for rendering the various user interface elements for providing the user with access to various applications. Digital twin tools 1565 may provide various functionality for modifying the digital twin 1562. Application tools 1566 may include various libraries for performing functionality for fetching network topology representations, determining attenuation of signals between devices, constricting or reconstructing network topologies, reorganizing network topologies based on power numbers, etc.

The storage 1560 may also include a collection of databases 1570 to aid in the creation of power numbers. As such, the databases 1570 may may include a device power income history database 1571 for determining average power numbers for a device (or portions thereof), a database of device throughput power models 1573, a database of device power consumption models 1572, and so on.

While the hardware device 1500 is shown as including one of each described component, the various components may be duplicated in various embodiments. For example, the processor 1520 may include multiple microprocessors that are configured to independently execute the methods described herein or are configured to perform steps or subroutines of the methods described herein such that the multiple processors cooperate to achieve the functionality described herein, such as in the case where the device 1500 participates in a distributed processing architecture with other devices which may be similar to device 1500. Further, where the device 1500 is implemented in a cloud computing system, the various hardware components may belong to separate physical systems. For example, the processor 1520 may include a first processor in a first server and a second processor in a second server.

It should be apparent from the foregoing description that various example embodiments of the invention may be implemented in hardware or firmware. Furthermore, various exemplary embodiments may be implemented as instructions stored on a machine-readable non-transitory storage medium, which may be read and executed by at least one processor to perform the operations described in detail herein. A machine-readable non-transitory storage medium may include any mechanism for storing information in a form readable by a machine, such as a personal or laptop computer, a server, or other computing device. Thus, a machine-readable non-transitory storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, and the like represent various processes which may be substantially represented in machine readable media and so executed by a computer or processor, whether or not such computer or processor is explicitly shown.

Although the various example embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

We claim:

1. A system comprising:
a memory configured to store:
(i) historical power income data for each of a plurality of wireless devices, each of the plurality of wireless devices having a variable power source;
(ii) power consumption data for each of the plurality of wireless devices; and
(iii) power throughput cost data associated with forwarding communications for additional devices; and
a processor in communication with the memory, the processor configured to:
determine, for at least one wireless device of the plurality of wireless devices, an average power income over a selected historical time period using the stored historical power income data;
determine an average power consumption for the at least one wireless device over the selected historical time period using the stored power consumption data;
calculate an excess power value for the at least one wireless device based on a difference between the average power income and the average power consumption;
determine, based on the excess power value and the stored power throughput cost data, an allowed number of descendant wireless devices supportable by the at least one wireless device without entering a negative power condition;
construct a network tree among the plurality of wireless devices such that a number of descendant wireless devices assigned to the at least one wireless device does not exceed the allowed number of descendant wireless devices; and
route at least one message through the network tree.

2. The system of claim 1, wherein the selected historical time period comprises at least one complete daily light cycle.

3. The system of claim 1, wherein the processor is further configured to determine the average power income using a rolling time window updated at predetermined intervals.

4. The system of claim 1, wherein the historical power income data comprises solar energy harvested by each wireless device and stored battery charge measurements recorded over time.

5. The system of claim 1, wherein determining the allowed number of descendant wireless devices comprises dividing the excess power value by an average per-device throughput energy cost.

6. The system of claim 5, wherein the average per-device throughput energy cost includes energy required for both transmission and reception of forwarded messages.

7. The system of claim 1, wherein constructing the network tree further comprises selecting parent-child relationships based in part on estimated signal strength between wireless devices.

8. The system of claim 7, wherein the estimated signal strength is determined using attenuation modeling that accounts for at least one structural obstacle between two wireless devices.

9. The system of claim 8, wherein attenuation modeling includes determining material composition and thickness of the at least one structural obstacle using a stored structural map.

10. The system of claim 1, wherein the processor is further configured to periodically recalculate the allowed number of descendant wireless devices and reorganize the network tree when a change in historical power income exceeds a predefined threshold.

11. A method performed by a processor for managing a variable power wireless device network, the method comprising:
storing historical power income data for each of a plurality of wireless devices, each of the plurality of wireless devices having a variable energy source;
calculating, for at least one wireless device of the plurality of wireless devices, an average historical power income over a selected time period;
determining an excess energy value for the at least one wireless device based on the average historical power income and a modeled power consumption rate;
determining, based on the excess energy value, a maximum number of descendant wireless devices supportable by the at least one wireless device;
constructing a hierarchical network tree among the plurality of wireless devices such that the at least one wireless device is assigned no more than the maximum number of descendant wireless devices; and
routing at least one communication message through the hierarchical network tree.

12. The method of claim 11, wherein constructing the hierarchical network tree comprises generating a graph representation of candidate communication links and selecting parent-child relationships using a shortest-path algorithm constrained by the maximum number of descendant wireless devices.

13. The method of claim 11, further comprising modeling signal strength between pairs of wireless devices by determining a radiation gain associated with an antenna orientation of at least one wireless device.

14. The method of claim 11, further comprising updating the maximum number of descendant wireless devices based on a predicted change in device reporting frequency.

15. The method of claim 11, wherein determining the excess energy value comprises subtracting a projected idle power consumption from the average historical power income.

16. The method of claim 11, further comprising reassigning at least one descendant wireless device from a first parent device to a second parent device when the first parent device exceeds the maximum number of descendant wireless devices.

17. A machine-readable non-transitory storage medium encoded with instructions which, when executed by a processor, cause the processor to perform operations comprising:
storing historical power income data for each of a plurality of wireless devices, each of the plurality of wireless devices having a variable energy source;
determining, for at least one wireless device of the plurality of wireless devices, an average power income over a selected historical time period using the stored historical power income data;
determining an average power consumption for the at least one wireless device over the selected historical time period;
calculating an excess energy value for the at least one wireless device based on a difference between the average power income and the average power consumption;
determining, based on the excess energy value and a modeled per-descendant communication energy cost, a maximum number of descendant wireless devices supportable by the at least one wireless device without entering a sustained negative energy balance condition;
constructing a network tree among the plurality of wireless devices such that the at least one wireless device is assigned no more than the maximum number of descendant wireless devices; and
routing at least one communication message through the network tree.

18. The machine-readable non-transitory storage medium of claim 17, wherein determining the maximum number of descendant wireless devices comprises normalizing the excess energy value by a projected bidirectional throughput cost per descendant device, the projected bidirectional throughput cost including energy associated with relayed acknowledgments and retransmissions.

19. The machine-readable non-transitory storage medium of claim 17, wherein constructing the network tree comprises iteratively reassigning parent-child relationships using a priority queue ordered by distance to a root node while enforcing that every device in a chain from a descendant device to the root node remains within its respective maximum number of descendant wireless devices.

20. The machine-readable non-transitory storage medium of claim 17, wherein determining the average power income over the selected historical time period further comprises smoothing transient energy spikes using a multi-cycle averaging model that spans multiple complete environmental energy cycles.
